(19) United States
(12) Patent Application Publication
(10) Pub. No.: US 2026/0251992 A1
(43) Pub. Date: Aug. 27, 2026

(54) TONER

(71) Applicant: CANON KABUSHIKI KAISHA, Tokyo (JP)

(72) Inventors: Mizuho HANATANI, Chiba (JP); Takeshi HASHIMOTO, Ibaraki (JP); Hayato IDA, Ibaraki (JP)

(21) Appl. No.: 19/543,465

(22) Filed: Feb. 18, 2026

(30) Foreign Application Priority Data
Feb. 25, 2025 (JP) 2025-027676
Jan. 23, 2026 (JP) 2026-009441

(51) Int. Cl. G03G 9/087; G03G 9/093

(52) U.S. Cl. CPC G03G 9/08755; G03G 9/09342

(57) ABSTRACT

Toner that improves a charging rise speed under a high-humidity environment while maintaining an improvement in image quality due to a reduction in a static adhesion force under a low-humidity environment is provided. The toner includes toner particles containing an amorphous polyester, and barium titanate particles present on a surface of the toner particles, wherein the amorphous polyester includes a carboxy group. The barium titanate particles include a barium titanate core and a fatty acid having carbon number 6 or more firmly fixed to a surface of the barium titanate core. A hydroxy group amount of the barium titanate particles measured using a titration method is 15 μmol/g or more and 1300 μmol/g or less.

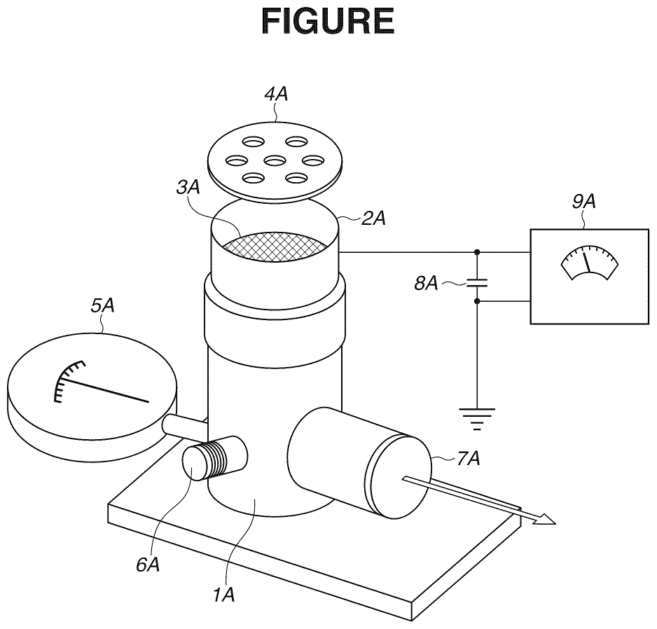

### BACKGROUND

### Field of the Technology

The present disclosure relates to toner used in an electrophotographic method, an electrostatic recording method, and the like.

### Description of the Related Art

In image formation using an electrophotographic method, toner including toner particles is used. The toner is used as a one-component developer or used as a two-component developer by being mixed with a carrier.

For example, the toner particles include toner base particles and an external additive attached to the surface of the toner base particles. For example, as the external additive, barium titanate particles are used. For example, the barium titanate exerts the function of stabilizing the amount of charge of the toner particles under a low-humidity environment.

Consequently, the toner using the barium titanate particles can improve image quality after endurance by preventing an increase in a static adhesion force under a low-humidity environment.

Japanese Patent Laid-Open No. 2021-131520 considers the prevention of excessive charging of static charge image development toner in a low-temperature and low-humidity environment in toner including, as an external additive, lanthanum-containing barium titanate subjected to a hydrophobization process.

WO2007/086451 considers improvements in the fluidity and the electrical characteristics of toner including, as an external additive, barium titanate manufactured through a hydrophobization step after titanium hydroxide and a barium compound are caused to react and subjected to heating treatment.

In the above toner using the barium titanate particles as the external additive, however, a charging rise speed becomes small and a change in image density becomes great under a high-humidity environment.

### SUMMARY

The present disclosure is directed to providing toner that improves a charging rise speed under a high-humidity environment while maintaining an improvement in image quality due to a reduction in a static adhesion force under a low-humidity environment.

According to an aspect of the present disclosure, toner includes toner particles containing an amorphous polyester, and barium titanate particles present on a surface of the toner particles, wherein the amorphous polyester includes a carboxy group, wherein (i) the barium titanate particles include a barium titanate core and a fatty acid having carbon number 6 or more firmly fixed to a surface of the barium titanate core, and wherein (ii) a hydroxy group amount of the barium titanate particles measured using a titration method is 15 μmol/g or more and 1300 μmol/g or less.

Features of the present disclosure will become apparent from the following description of embodiments with reference to the attached drawings. The following description of embodiments is described by way of example.

### BRIEF DESCRIPTION OF THE DRAWINGS

FIGURE is a diagram illustrating an amount-of-friction-charge measurement apparatus used to measure an amount of charge of toner.

### DESCRIPTION OF THE EMBODIMENTS

In the present disclosure, the description “◯◯ or more and xx or less” or “◯◯ to xx” indicating a numerical range means a numerical range including the lower limit and the upper limit as the end points of the numerical range, unless otherwise noted. A “monomer unit” refers to a form in which a monomer substance in a polymer has reacted. Further, toner particles are occasionally referred to as “toner base particles” or a “toner base”.

### Features of Present Disclosure

The present inventors consider a mechanism where the effects of the present disclosure appear as follows.

As a result of the consideration of the present inventors, it has been found that to improve a charging rise at high humidity, an external additive needs to be charged, and generated charges need to be rapidly moved to a toner base.

However, since conventional barium titanate has low resistance, the action of charge leakage is greater than the action of charge generation. As a result, charges are less likely to be generated, and it is difficult to improve a charging rise.

In conventional barium titanate particles, generated charges are less likely to move, and the barium titanate particles are locally charged. Thus, it takes time before charging is saturated, and it is difficult to improve a charging rise.

Then, as a result of diligent consideration, the present inventors have found out that it is possible to achieve both a reduction in a static adhesion force under a low-humidity environment and an improvement in a charging rise speed under a high-humidity environment by containing an amorphous polyester including a carboxylic acid in toner base particles, and by making a fatty acid having carbon number 6 or more and barium titanate including 15 μmol/g or more and 1300 μmol/g or less of a hydroxy group present on the surface of the toner, and have arrived at the present disclosure.

Although the mechanism of this is not clear, the present inventors consider that charges are generated due to the presence of an appropriate amount of the hydroxy group on the surface of the barium titanate, and the charges are diffused into the toner base particles due to the low resistance of the barium titanate core, whereby it is possible to improve a charging rise under a high-humidity environment. Further, the present inventors presume that the fatty acid is made present in the barium titanate, and the amorphous polyester including the carboxylic acid is made present in the toner base particles, whereby the charges are likely to be held in the toner base particles due to the interaction of the fatty acid in the barium titanate and the carboxylic acid in the toner base particles, and it is possible to improve a charging rise under a high-humidity environment.

The present inventors also consider that since the barium titanate has high permittivity under a low-humidity environment, the dielectric relaxation speed is fast, and therefore, the apparent amount of charge is reduced, whereby it is possible to reduce a static adhesion force under a low-humidity environment.

The barium titanate particles used in the present disclosure include a fatty acid having carbon number 6 or more firmly fixed to the surface of the barium titanate core. If the fatty acid is within the above range, a charging rise under a high-humidity environment is improved due to the interaction of the fatty acid with the carboxylic acid in the amorphous polyester in the toner base particles. If the fatty acid is outside the above range, the interaction of the fatty acid with the carboxylic acid in the amorphous polyester is small, and therefore, the effects of the present disclosure are not obtained.

The hydroxy group amount of the barium titanate measured using a titration method is 15 μmol/g or more and 1300 μmol/g or less. If the hydroxy group amount is within the above range, it is possible to achieve both a reduction in a static adhesion force under a low-humidity environment and an improvement in a charging rise under a high-humidity environment.

If the hydroxy group amount is smaller than 15 μmol/g, charges are less likely to be generated under a high-humidity environment, and therefore, the effects of the present disclosure are not obtained. If the hydroxy group amount is greater than 1300 μmol/g, the barium titanate particles are excessively charged under a low-humidity environment, and a static adhesion force becomes great. Thus, the effects of the present disclosure are not obtained.

Examples of a method for making the hydroxy group amount small include a method for making the reaction temperature high in a reaction step in the manufacturing of the barium titanate, and a method for increasing the additive amount of the fatty acid in a fatty acid surface treatment step. Examples of a method for making the hydroxy group amount great include a method for making the reaction temperature low in the reaction step in the manufacturing of the barium titanate, and a method for decreasing the additive amount of the fatty acid in the fatty acid surface treatment step.

### [Barium Titanate Particles]

Next, the barium titanate particles used in the present disclosure are described in detail.

It is desirable that the number average particle diameter of the barium titanate particles be 0.02 μm or more and 0.12 μm or less. If the number average particle diameter of the barium titanate particles is within the above range, the barium titanate particles and carrier particles are likely to come into contact with each other, and therefore, the effect of improving a charging rise is likely to be obtained. If the number average particle diameter of the barium titanate particles is less than 0.02 μm, the barium titanate particles and the carrier particles are less likely to come into contact with each other, and therefore, the effect of improving a charging rise is less likely to be obtained. If the number average particle diameter exceeds 0.12 μm, there is a possibility that the barium titanate particles are likely to be separated from the toner base particles. The number average particle diameter of the barium titanate particles can be made small by making the reaction time in the reaction step in the manufacturing of the barium titanate short. The number average particle diameter of barium titanate particles can be made great by making the reaction time long in the reaction step in the manufacturing of the barium titanate particles.

The hydroxy group amount of the barium titanate particles measured using a titration method is 15 μmol/g or more and 1300 μmol/g or less. It is desirable that the hydroxy group amount be 120 μmol/g or more and 450 μmol/g or less. If the hydroxy group amount is within the above range, a charging rise under a high-humidity environment is improved, and the effect of reducing a static adhesion force under a low-humidity environment is likely to be obtained. The hydroxy group amount of the barium titanate particles can be made great by making the additive amount of a surface treatment agent small, or making the reaction temperature low, or making the reaction time short in a surface treatment step in the manufacturing of the barium titanate particles. The hydroxy group amount of the barium titanate particles can be made small by making the additive amount of the surface treatment agent great, or making the reaction temperature high, or making the reaction time long in the surface treatment step in the manufacturing of the barium titanate particles.

It is desirable that the barium titanate particles include a fatty acid having carbon number 6 or more firmly fixed to the surface of the barium titanate core particles. It is more desirable that the carbon number of the fatty acid be 12 or more and 24 or less. It is even more desirable that the fatty acid be stearic acid. If the fatty acid is within the above range, the interaction of the fatty acid with the carboxylic acid in the amorphous polyester is great, and a charging rise under a high-humidity environment is improved. If the fatty acid is stearic acid, the interaction is greatest, and the effect of improving a charging rise under a high-humidity environment is further obtained.

Examples of the fatty acid having carbon number 6 or more include the following.

Examples of the fatty acid include caproic acid, heptanoic acid, caprylic acid, nonanoic acid, capric acid, undecanoic acid, lauric acid, tridecanoic acid, myristic acid, pentadecanoic acid, palmitic acid (hexadecanoic acid), margaric acid (heptadecanoic acid), stearic acid (octadecanoic acid), nonadecanoic acid, arachidic acid (icosanoic acid), heneicosanoic acid, behenic acid (docosanoic acid), tricosanoic acid, and tetracosanoic acid.

It is desirable that the barium titanate particles include 0.50 mass % or more and 5.00 mass % or less of the fatty acid. If the fatty acid included in the barium titanate particles is within the above range, the interaction of the fatty acid with the carboxylic acid in the amorphous polyester is great, charges can be moderately generated under a high-humidity environment, and a charging rise can be improved.

The amount of the fatty acid contained in the barium titanate particles can be made small by making the additive amount of the fatty acid small, or making the reaction temperature low, or making the reaction time short in a fatty acid surface treatment step in the manufacturing of the barium titanate particles. The amount of the fatty acid contained in the barium titanate particles can be made great by making the additive amount of the fatty acid great, or making the reaction temperature high, or making the reaction time long in the fatty acid surface treatment step in the manufacturing of the barium titanate particles.

When the hydroxy group amount of the barium titanate particles is A (μmol/g) and the carboxy group amount of the fatty acid firmly fixed to the surface of the barium titanate core particles is B (μmol/g), it is desirable that a ratio A/B be 0.7 or more and 30.0 or less. If the ratio A/B is within the above range, the effects of reducing a static adhesion force under a low-humidity environment and improving a charging rise under a high-humidity environment are likely to be obtained.

Although a method for manufacturing the barium titanate particles used in the present disclosure is not particularly limited, it is desirable that the method be a wet method such as a hydrothermal synthesis method or the like, and be a manufacturing method not through a firing step at 100° C. or more. If the method includes the firing step, it is difficult to set the hydroxy group to 15 μmol/g or more and 1300 μmol/g or less.

An example of the method for manufacturing the barium titanate particles is described below. First, a processed product (hereinafter occasionally referred to as a “titanium source peptization processed product”) obtained by performing a peptization process on a titanium source with a mineral acid is mixed with a barium compound. Next, while the obtained mixture is heated to a temperature of 50° C. or more, an alkali aqueous solution is added to the mixture. Next, the mixture to which the alkali aqueous solution is added is held at a temperature of 50° C. or more for a predetermined time (e.g., 30 minutes or more and 2 hours or less). Next, after the obtained product is cooled, hydrochloric acid is added to the product, thereby obtaining a precipitate. Next, after the obtained precipitate is washed and filtered (subjected to solid-liquid separation), the obtained solid content is dried, thereby obtaining a powder of the barium titanate particles.

An example of a method for treating the surface of the barium titanate particles with the fatty acid is described. The fatty acid is dissolved into an organic solvent such as toluene or the like, and the barium titanate particles are added to the obtained product while being agitated. This mixture is dried, and the organic solvent is evaporated, thereby obtaining the barium titanate particles to the surface of which the fatty acid is firmly fixed.

The amount of the fatty acid firmly fixed to the surface of the barium titanate core can be adjusted by, for example, changing the amount of the fatty acid to be added relative to the mass of the barium titanate particles.

It is desirable that the amount of the contained barium titanate particles be 0.10 parts by mass or more and 5.00 parts by mass or less relative to 100 parts by mass of the toner particles. If the amount of the contained barium titanate particles is within the above range, the amount of the barium titanate particles present on the toner base particles is moderate, and charges are less likely to leak. Thus, the effect of improving a charging rise at high humidity is less likely to be obtained.

### [Toner Particles]

Next, the configuration of the toner particles to which the barium titanate particles are externally added is described in detail. The toner particles contain a binding resin and also contain a colorant, a wax, or the like where necessary.

### <Binding Resin>

The toner particles according to the present disclosure contain an amorphous polyester as a binding resin. If the toner particles contain an amorphous polyester, the following polymers or resins can also be used in addition to the amorphous polyester.

For example, styrenes such as polystyrene, poly-α-chlorostyrene, polyvinyl toluene, and the like and homopolymers of substitution products of these; styrene copolymers such as styrene-p-chlorostyrene copolymers, styrene-vinyl toluene copolymers, styrene-vinylnaphthalene copolymers, styrene-acrylic acid ester copolymers, styrene-methacrylic acid ester copolymers, styrene-α-chloromethacrylic acid methyl copolymers, styrene-acrylonitrile copolymers, styrene-methyl vinyl ether copolymers, styrene-ethyl vinyl ether copolymers, styrene-methyl vinyl ketone copolymers, styrene-acrylonitrile-indene copolymers, and the like; and polyvinyl chloride, phenolic resins, natural modified phenolic resins, natural resin-modified maleic acid resins, acrylic resins, methacrylic resins, polyvinyl acetate, silicone resins, polyesters, polyurethanes, polyamide resins, furan resins, epoxy resins, xylene resins, polyvinyl butyral, terpene resins, coumarone-indene resins, petroleum resins, and the like can be used. Among these, polyesters are desirable in terms of charging stability.

### <Amorphous Polyester>

The amorphous polyester used in the present disclosure needs to include a carboxy group in terms of a charging rise under a high-humidity environment. The amount of the carboxy group can be controlled by the acid value in the resin. It is desirable that the acid value be in the range of 5 mgKOH/g or more and 20 mgKOH/g or less in terms of a charging rise under a high-humidity environment. The acid value can be controlled by the ratio and the molecular weights of a polycarboxylic acid and a polyalcohol described below.

The amorphous polyester can be obtained by copolymerizing a polycarboxylic acid and a polyalcohol. Examples of the carboxylic acid to be used include the following polycarboxylic acids.

Examples of a bivalent carboxylic acid include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, and the like. Among these, maleic acid, fumaric acid, and terephthalic acid are desirable.

Examples of a trivalent or higher carboxylic acid can include the following.

Examples of the trivalent or higher carboxylic acid can include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, Empol trimer acid, acid anhydrides of these, lower alkyl esters of these, and the like.

Among these, 1,2,4-benzenetricarboxylic acid (i.e., trimellitic acid) or a derivative of this is desirable because the 1,2,4-benzenetricarboxylic acid is inexpensive, and the reaction of the 1,2,4-benzenetricarboxylic acid is easy to control.

One type alone or two or more types in combination of these bivalent carboxylic acids and trivalent or higher carboxylic acids can be used.

It is desirable that the molecular chain terminal of the amorphous polyester be capped by a monoalcohol or a monocarboxylic acid.

If the amorphous polyester includes a branched chain, the molecular chain terminal also includes the terminal of the branched chain. It is more desirable that the monoalcohol and the monocarboxylic acid be a straight-chain alkyl monoalcohol and a straight-chain alkyl monocarboxylic acid, respectively, in terms of a charging rise under a high-humidity environment.

Examples of the straight-chain alkyl monocarboxylic acid include the following.

Examples of the straight-chain alkyl monocarboxylic acid include palmitic acid (hexadecanoic acid), margaric acid (heptadecanoic acid), stearic acid (octadecanoic acid), nonadecylic acid, arachidic acid (icosanoic acid), heneicosylic acid, behenic acid (docosanoic acid), tricosanoic acid, and tetracosanoic acid.

Examples of the straight-chain alkyl monoalcohol include the following.

Examples of the straight-chain alkyl monoalcohol include palmityl alcohol (hexadecanol), heptadecanol, stearyl alcohol (octadecanol), nonadecanol, arachidyl alcohol (icosanol), heneicosanol, behenyl alcohol, lignoceryl alcohol, tricosanol, and tetracosanol.

It is desirable that the number average molecular weight of the amorphous polyester be 2000 or more and 10000 or less in terms of control of the acid value. The number average molecular weight of the amorphous polyester can be controlled by the reaction time, the reaction temperature, the catalytic amount, and the pressure reduction degree in a method for manufacturing the polyester described below.

The amorphous polyester can be manufactured according to a normal polyester synthesis method.

For example, after the above carboxylic acid component and the above alcohol component are caused to perform an esterification reaction or a transesterification reaction, the carboxylic acid component and the alcohol component are caused to perform a condensation polymerization reaction according to an ordinary method under reduced pressure or by introducing nitrogen gas, whereby a desired polyester can be obtained.

However, when the carboxylic acid component and the alcohol component perform a reaction, and if the straight-chain alkyl monocarboxylic acid or the straight-chain alkyl monoalcohol is present at the same time, a straight alkyl compound forms a molecular chain terminal. Thus, there is a possibility that the straight alkyl compound functions as an end cap, and the molecular chain becomes extremely short. Accordingly, the straight alkyl compound may be added into the reaction system in the second half of the reaction.

The esterification or transesterification reaction can be performed using a normal esterification catalyst or a normal transesterification catalyst, such as sulfuric acid, titanium butoxide, dibutyltin oxide, tin (II) 2-ethylhexanoate, manganese acetate, magnesium acetate, or the like, where necessary. The condensation polymerization reaction can be performed using a normal polymerization catalyst such as a known catalyst, e.g., titanium butoxide, dibutyltin oxide, 2-ethylhexanoate, tin acetate, zinc acetate, tin disulfide, antimony trioxide, germanium dioxide, or the like. The polymerization temperature and the catalytic amount are not particularly limited, either, and may be appropriately determined.

### <Crystalline Polyester>

It is desirable that the toner according to the present disclosure contain a crystalline polyester. If the toner contains the crystalline polyester, charges moderately leak by the barium titanate and the crystalline polyester exchanging charges. Thus, the amount of charge can be moderately maintained under a low-humidity environment.

As a component used to synthesize the crystalline polyester, a polyalcohol (a bivalent or trivalent or higher alcohol), a polycarboxylic acid (a bivalent or trivalent or higher carboxylic acid), an acid anhydride of this, or a lower alkyl ester of this is used. It is desirable that the main chain of the crystalline polyester be a condensation polymer of an aliphatic dicarboxylic acid and an aliphatic diol.

Examples of the polyalcohol used to synthesize the crystalline polyester include the following polyalcohols. Although the polyalcohol is not particularly limited, it is desirable that the polyalcohol be a chain (more desirably, straight-chain) aliphatic diol. Examples of the polyalcohol include ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Among these, particularly, linear aliphatic groups and α,ω-diols, such as ethylene glycol, diethylene glycol, 1,4-butanediol, and 1,6-hexanediol, are desirably illustrated as examples.

A polyalcohol other than the above polyalcohols can also be used. Examples of the bivalent alcohol include: aromatic alcohols such as polyoxyethylenated bisphenol A, polyoxypropylenated bisphenol A, and the like; 1,4-cyclohexanedimethanol; and the like. Examples of the trivalent or higher polyalcohol include aromatic alcohols such as 1,3,5-trihydroxymethylbenzene and the like; aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, trimethylolpropane, and the like; and the like.

As the polycarboxylic acid used for the crystalline polyester, the following polycarboxylic acids can be used. Although the polycarboxylic acid is not particularly limited, it is desirable that the polycarboxylic acid be a chain (more desirably, straight-chain) aliphatic dicarboxylic acid. Specific examples of the polycarboxylic acid include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid, and also include products obtained by hydrolyzing acid anhydrides or lower alkyl esters of these, and the like.

A polycarboxylic acid other than the above polycarboxylic acids can also be used. Examples of the bivalent carboxylic acid among the other polycarboxylic acids include: aromatic carboxylic acids such as isophthalic acid, terephthalic acid, and the like; aliphatic carboxylic acids such as n-dodecylsuccinic acid and n-dodecenylsuccinic acid; and alicyclic carboxylic acids such as cyclohexane dicarboxylic acid and the like, and also include acid anhydrides or lower alkyl esters of these and the like.

Examples of the trivalent or higher polycarboxylic acid among the other carboxylic acid monomers include aromatic carboxylic acids such as 1,2,4-benzenetricarboxylic acid (trimellitic acid), 2,5,7-naphthalenetricarboxylic acid, 1,2,4-naphthalenetricarboxylic acid, pyromellitic acid, and the like, and aliphatic carboxylic acids such as 1,2,4-butanetricarboxylic acid, 1,2,5-hexanetricarboxylic acid, 1,3-dicarboxyl-2-methyl-2-methylenecarboxypropane, and the like, and also include derivatives such as acid anhydrides, lower alkyl esters, and the like of these, and the like.

It is more desirable that the crystalline polyester contain a modified crystalline polyester terminal-modified with an aliphatic monoalcohol or an aliphatic monocarboxylic acid in terms of control of a static adhesion force under a low-humidity environment. The terminal of the crystalline polyester and the fatty acid on the barium titanate interact with each other, whereby the barium titanate and the crystalline polyester are more likely to exchange charges, and charges moderately leak. Thus, the amount of charge can be moderately maintained under a low-humidity environment.

If the crystalline polyester includes a branched chain, the molecular chain terminal also includes the terminal of the branched chain. It is more desirable that the monoalcohol and the monocarboxylic acid be a straight-chain alkyl monoalcohol and a straight-chain alkyl monocarboxylic acid, respectively, in terms of a charging rise under a high-humidity environment.

Examples of the straight-chain alkyl monocarboxylic acid include the following.

Examples of the straight-chain alkyl monocarboxylic acid include palmitic acid (hexadecanoic acid), margaric acid (heptadecanoic acid), stearic acid (octadecanoic acid), nonadecylic acid, arachidic acid (icosanoic acid), heneicosylic acid, behenic acid (docosanoic acid), tricosanoic acid, and tetracosanoic acid.

Examples of the straight-chain alkyl monoalcohol include the following.

Examples of the straight-chain alkyl monoalcohol include palmityl alcohol (hexadecanol), heptadecanol, stearyl alcohol (octadecanol), nonadecanol, arachidyl alcohol (icosanol), heneicosanol, behenyl alcohol, lignoceryl alcohol, tricosanol, and tetracosanol.

It is desirable that the number average molecular weight of the crystalline polyester be 2000 or more and 10000 or less. The number average molecular weight of the crystalline polyester can be controlled by the reaction time, the reaction temperature, the catalytic amount, and the pressure reduction degree in a method for manufacturing the polyester described below.

The crystalline polyester can be manufactured according to a normal polyester synthesis method. For example, after the above carboxylic acid monomer and the above alcohol monomer are caused to perform an esterification reaction or a transesterification reaction, the carboxylic acid monomer and the alcohol monomer are caused to perform a polycondensation reaction according to an ordinary method under reduced pressure or by introducing nitrogen gas, whereby the crystalline polyester can be obtained. Then, further, the above aliphatic compound is added, and the obtained product is caused to perform an esterification reaction, whereby a desired crystalline polyester can be obtained.

The esterification or transesterification reaction can be performed using a normal esterification catalyst or a normal transesterification catalyst, such as sulfuric acid, titanium butoxide, dibutyltin oxide, manganese acetate, magnesium acetate, or the like, where necessary.

The polycondensation reaction can be performed using a normal polymerization catalyst such as a known catalyst, e.g., titanium butoxide, dibutyltin oxide, tin acetate, zinc acetate, tin disulfide, antimony trioxide, germanium dioxide, or the like. The polymerization temperature and the catalytic amount are not particularly limited, and may be appropriately determined.

In the esterification or transesterification reaction or the polycondensation reaction, a method for collectively preparing all monomers to increase the strength of the crystalline polyester to be obtained, a method for causing a bivalent monomer to react first, then adding a trivalent or higher monomer, and causing the obtained product to react to reduce a low-molecular-weight component, or the like may be used.

In the synthesis of the crystalline polyester including the modified crystalline polyester, it is desirable that at least one (desirably, the above aliphatic monocarboxylic acid) selected from the group composed of the above aliphatic monocarboxylic acids and the above aliphatic monoalcohols, an aliphatic diol, and an aliphatic dicarboxylic acid be condensation-polymerized. It is desirable that the proportion of the aliphatic diol be 30 mol % or more and 50 mol % or less. It is more desirable that the proportion of the aliphatic diol be 35 mol % or more and 45 mol % or less. It is desirable that the proportion of the aliphatic dicarboxylic acid be 5 mol % or more and 45 mol % or less. It is more desirable that the proportion of the aliphatic dicarboxylic acid be 10 mol % or more and 35 mol % or less. It is desirable that the proportion of the at least one (desirably, the above aliphatic monocarboxylic acid) selected from the group composed of the above aliphatic monocarboxylic acids and the above aliphatic monoalcohols be 15 mol % or more and 60 mol % or less. It is more desirable that the proportion of the at least one (desirably, the above aliphatic monocarboxylic acid) selected from the group composed of the above aliphatic monocarboxylic acids and the above aliphatic monoalcohols be 20 mol % or more and 30 mol % or less.

It is desirable that the total content proportion of a monomer unit based on the aliphatic monocarboxylic acid and a monomer unit based on the aliphatic monoalcohol included in the terminal-modified structure of the crystalline polyester be 1.0 mass % or more and 30.0 mass % or less. It is more desirable that the total content proportion of the monomer units be 2.0 mass % or more and 25.0 mass % or less.

It is desirable that the amount of the crystalline polyester contained in the toner particles be 1.0 parts by mass or more and 15.0 parts by mass or less relative to 100 parts by mass of the binding resin. It is more desirable that the amount of the crystalline polyester be 3.0 parts by mass or more and 15.0 parts by mass or less relative to 100 parts by mass of the binding resin in terms of a reduction in a static adhesion force under a low-humidity environment.

### <Colorant>

In the toner particles, a colorant may be used where necessary. Examples of the colorant include the following.

Examples of a black colorant include: carbon black; and a colorant toned to black using a yellow colorant, a magenta colorant, and a cyan colorant. As the colorant, a pigment alone may be used, but it is more desirable to improve the vividness of the colorant by using a dye and a pigment in combination in terms of the image quality of a full-color image.

Examples of a magenta toner pigment include: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of a magenta toner dye include: oil-soluble dyes such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1, and basic dyes such as C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

Examples of a cyan toner pigment include: C.I. Pigment Blue 2, 3, 15:2, 15:3, 15:4, 16, and 17; C.I. Vat Blue 6; C.I. Acid Blue 45; and copper phthalocyanine pigments obtained by substituting one to five phthalimidomethyl groups for a phthalocyanine skeleton.

Examples of a cyan toner dye include C.I. Solvent Blue 70.

Examples of a yellow toner pigment include: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of a yellow toner dye include C.I. Solvent Yellow 162.

It is desirable that the amount of the contained colorant be 0.1 parts by mass or more and 30.0 parts by mass or less relative to 100 parts by mass of the binding resin.

### <Wax>

In the toner particles, a wax may be used where necessary. Examples of the wax include the following.

Examples of the wax include: hydrocarbon waxes such as microcrystalline waxes, paraffin waxes, and Fischer-Tropsch waxes; oxides of hydrocarbon waxes, such as oxidized polyethylene waxes, or block copolymers of these; waxes including fatty acid esters as main components, such as Carnauba wax; and waxes obtained by deacidifying part or the entirety of fatty acid esters, such as deacidified carnauba wax.

Examples of the wax further include: saturated straight-chain fatty acids such as palmitic acid, stearic acid, and montanoic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyalcohols such as sorbitol; esters of fatty acids such as palmitic acid, stearic acid, behenic acid, and montanoic acid, and alcohols such as stearyl alcohol, aralkyl alcohol, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyl adipic acid amide, and N,N′-dioleyl sebacic acid amide; aromatic bisamides such as m-xylene bisstearic acid amide and N,N′-distearyl isophthalic acid amide; aliphatic metallic salts (generally termed metallic soaps) such as calcium stearate, calcium laurate, zinc stearate, and magnesium stearate; waxes obtained by grafting aliphatic hydrocarbon waxes using vinyl monomers such as styrene and acrylic acid; partially esterified compounds of fatty acids and polyalcohols, such as behenic acid monoglyceride; and methyl ester compounds including hydroxyl groups obtained by adding hydrogen to vegetable oils.

It is desirable that the amount of the contained wax be 2.0 parts by mass or more and 30.0 parts by mass or less relative to 100 parts by mass of the binding resin.

### <Charge Control Agent>

The toner particles can also contain a charge control agent where necessary. As the charge control agent contained in the toner, a known charge control agent can be used. It is particularly desirable that the charge control agent be a metal compound of an aromatic carboxylic acid, which is colorless, achieves the fast charging speed of the toner, and can stably hold a constant amount of charge.

Examples of a negative charge control agent include salicylic acid metal compounds, naphthoic acid metal compounds, dicarboxylic acid metal compounds, polymer compounds having sulfonic acids or carboxylic acids as side chains, polymer compounds having sulfonates or sulfonic acid esterified compounds as side chains, polymer compounds having carboxylates or carboxylic acid esterified compounds as side chains, boron compounds, urea compounds, silicon compounds, and calixarenes. The charge control agent may be internally added or externally added to the toner particles.

It is desirable that the additive amount of the charge control agent be 0.2 parts by mass or more and 10.0 parts by mass or less relative to 100 parts by mass of the binding resin.

### [Inorganic Microparticles (Other External Additives)]

In the toner according to the present disclosure, the above barium titanate is attached to the surface of the toner particles, and other inorganic microparticles can also be used in combination where necessary. The other inorganic microparticles may be internally added to the toner particles, or may be mixed as an external additive with the toner base particles. It is desirable that the external additive be inorganic microparticles such as silica. It is desirable that the inorganic microparticles be hydrophobized with a hydrophobizing agent such as a silane compound, a silicone oil, or a mixture of these.

It is desirable that the number average particle diameter of the inorganic microparticles be smaller than that of the barium titanate particles. If the number average particle diameter of the inorganic microparticles is greater than that of the barium titanate particles, the barium titanate particles and a carrier are less likely to come into contact with each other. Thus, the effects of the present disclosure are less likely to be obtained.

It is desirable that 0.1 parts by mass or more and 10.0 parts by mass or less of the inorganic microparticles relative to 100 parts by mass of the toner particles be used. If the above range is satisfied, the effect of charging stability is likely to be obtained.

It is desirable that the inorganic microparticles be strontium titanate particles or calcium titanate particles having a number average particle diameter of 0.02 μm or more and 0.12 μm or less. Under a high-temperature and low-humidity environment, the amount of charge becomes great, and a static adhesion force is likely to become great. However, the strontium titanate particles or the calcium titanate particles are made present on the surface of the toner particles, whereby the retention of charges can be prevented. As a result, even under a high-temperature and low-humidity environment, the effect of reducing a static adhesion force can be obtained.

If the number average particle diameter of the strontium titanate particles or the calcium titanate particles is within the above range, the strontium titanate particles or the calcium titanate particles and the barium titanate are likely to come into contact with each other, and charges are likely to flow. Thus, the effect of reducing a static adhesion force is likely to be obtained. When the number average particle diameter of the particle size of the barium titanate is S (μm) and the number average particle diameter of the strontium titanate particles or the calcium titanate particles is M (μm), it is desirable that a ratio S/M be 0.5 or more and 4.0 or less in terms of a reduction in a static adhesion force because the strontium titanate particles or the calcium titanate particles and the barium titanate are more likely to come into contact with each other, and charges are more likely to flow.

It is desirable that 0.1 parts by mass or more and 10.0 parts by mass or less of the strontium titanate particles or the calcium titanate particles relative to 100 parts by mass of the toner particles be used. If the above range is satisfied, the effect of charging stability is likely to be obtained.

### [Developer]

Although the toner according to the present disclosure can be used as a one-component developer, it is desirable that the toner be used as a two-component developer by being mixed with a magnetic carrier to further improve dot reproducibility and to supply stable images over a long period.

As the magnetic carrier, for example, generally known magnetic carriers such as an iron powder having an oxidized surface, an unoxidized iron powder, metal particles of iron, lithium, calcium, magnesium, nickel, copper, zinc, cobalt, manganese, chromium, or rare earths, alloy particles of these, oxide particles of these, magnetic substances such as ferrites and the like, magnetic substance dispersion resin carriers (so-called resin carriers) containing magnetic substances and binder resins holding the magnetic substances in dispersed states, and the like can be used.

If the toner is used as the two-component developer by being mixed with the magnetic carrier, it is desirable that the mixing rate be 2 mass % or more and 15 mass % or less as the toner density in the two-component developer. It is more desirable that the mixing rate be 4 mass % or more and 13 mass % or less.

### [Method for Manufacturing Toner Particles and Method for Manufacturing Toner]

A method for manufacturing the toner particles is not particularly limited, and a conventionally known manufacturing method such as a suspension polymerization method, an emulsion aggregation method, a melting kneading method, a dissolution suspension method, or the like can be employed.

The obtained toner particles are mixed with the barium titanate particles and also with another external additive where necessary. The toner particles can be mixed with the barium titanate particles and with another external additive using a mixing apparatus such as a double cone mixer, a V-shaped mixer, a drum-type mixer, a super mixer, a Henschel mixer, a Nauta mixer, Mechano Hybrid (manufactured by Nippon Coke & Engineering Co., Ltd.), Nobilta (manufactured by Hosokawa Micron Corporation), or the like

### [Methods for Measuring Various Physical Properties]

Methods for measuring various physical properties are described below.

### <Separation of External Additive and Toner Particles>

The external additive including the barium titanate particles can also be separated from the toner and measured using the following method.

200 g of Saccharose (manufactured by Kishida Chemical Co., Ltd.) is added to 100 mL of ion-exchanged water and dissolved into the ion-exchanged water while the obtained product is warmed in a bowl placed in hot water, thereby preparing a sucrose concentrate. 31 g of the sucrose concentrate and 6 mL of Contaminon N (a 10 mass % aqueous solution of a precise measuring device washing neutral detergent having a pH of 7 composed of a non-ionic surfactant, an anionic surfactant, and an organic builder, manufactured by FUJIFILM Wako Pure Chemical Corporation) are put in a centrifugal separation tube, thereby preparing a dispersion liquid. 1 g of the toner is added to this dispersion liquid, and a lump of the toner is loosened using a spatula or the like.

The centrifugal separation tube is shaken using a shaker for 20 minutes under the condition of 350 reciprocations per minute. After the shake, this solution is put in a swing rotor glass tube (50 mL) and is centrifuged under the conditions of 3500 rpm and 30 minutes by a centrifugal separator. In the glass tube after the centrifugal separation, the toner is present on the uppermost layer, and the inorganic microparticles are present on the aqueous solution side of a lower layer. The aqueous solution in the lower layer is collected and centrifuged, thereby separating the sucrose and the inorganic microparticles and collecting the inorganic microparticles. After the centrifugal separation is repeatedly performed where necessary, and the separation is sufficiently performed, the dispersion liquid is dried, and the inorganic microparticles are collected.

If a plurality of types of inorganic microparticles is added, the barium titanate particles can be sorted out using the centrifugal separation method or the like.

### <Method for Measuring Number Average Particle Diameters of Primary Particles of Barium Titanate Particles, Strontium Titanate Particles, and Calcium Titanate Particles>

The number average particle diameters of the barium titanate particles, the strontium titanate particles, and the calcium titanate particles are measured using scanning electron microscope “Ultra Plus” (product name; manufactured by Zeiss). Hydrophobically treated alumina microparticles are identified by an energy dispersive X-ray spectroscopy (SEM-EDS) analysis.

The toner is observed under the following conditions, the longest diameters of primary particles regarding 100 particles of the particles of each type are measured, and the average value of the obtained longest diameters is determined as the number average particle diameter. The observation magnification is appropriately adjusted depending on the sizes of the barium titanate particles, the strontium titanate particles, and the calcium titanate particles.

### (SEM Observation Conditions)

Sample preprocessing: the toner is fixed using a carbon tape and coated with platinum (Pt)
SEM acceleration voltage: 2.0 kV
WD: 2.8 mm
Detector: SE2
Resolution: 1024×768 pixels
Observation magnification: 5,000 to 50,000 times

### <Method for Measuring Hydroxy Group Amount A of Barium Titanate Particles>

A hydroxy group amount A (μmol/g) of the barium titanate particles can be obtained by measurement using a titration method. Specifically, a 4 mass % solution obtained by dispersing the dried barium titanate particles into ethanol was prepared. Next, the end of a probe of an ultrasonic disperser was immersed into the above solution, and the above solution was ultrasonically dispersed for 15 minutes with an output of 20 W, thereby obtaining a dispersion liquid 1. A 20% sodium chloride aqueous solution having an amount three times as much as that of the ethanol was added to the dispersion liquid 1, the end of the probe of the ultrasonic disperser was immersed into the above solution, and the above solution was ultrasonically dispersed for 15 minutes with an output of 20 W, thereby obtaining a dispersion liquid 2. A hydrogen chloride solution was added to the dispersion liquid 2 to obtain a pH of 5.0, and the titer (mol) at an inflection point of the titration curve of the obtained product was divided by the mass of the used barium titanate particles, thereby obtaining the hydroxy group amount A (μmol/g).

### <Method for Identifying Surface Treatment Agent of Barium Titanate Particles>

The surface treatment agent of the barium titanate is analyzed by a thermal decomposition gas chromatography mass analysis (GC-MS).

Specifically, the measurement conditions are as follows.

Apparatus: GC6890A (manufactured by Agilent Technologies Japan, Ltd.), thermal decomposition apparatus (manufactured by Japan Analytical Industry Co., Ltd.)

Column: HP-5 ms 30 m

Thermal decomposition temperature: 590° C.

Peak positions of a profile obtained by the measurement are identified using a standard sample, thereby identifying the surface treatment agent of the external additive.

### <Amount of Surface Treatment Material of Barium Titanate Particles>

The barium titanate particles were measured using a thermogravimetric/differential thermal analysis apparatus (TG-DTA, Thermo Plus TG8120 manufactured by Rigaku Corporation), temperature was raised from 25° C. to 400° C. at a speed of 10° C./min, and the amount of the surface treatment agent was measured based on a change in the mass of the barium titanate particles.

### <Method for Measuring Acid Value of Polyester>

The acid value is the mg number of potassium hydroxide required to neutralize an acid component such as a free fatty acid, a resin acid, or the like contained in 1 g of a sample. The acid value is measured as follows according to JIS-K0070-1992.

### (1) Reagent

1.0 g of phenolphthalein is dissolved into 90 mL of ethylalcohol (95 volume %), and ion-exchanged water is added to the obtained product, thereby obtaining 100 mL of a phenolphthalein solution.

7 g of special grade potassium hydroxide is dissolved into 5 mL of water, and ethylalcohol (95 volume %) is added, thereby obtaining 1 L of the obtained product. This product is put in an alkali-resistant container to avoid contact with carbon dioxide gas or the like, left for 3 days, and then filtered, thereby obtaining a potassium hydroxide solution. The obtained potassium hydroxide solution is stored in an alkali-resistant container. The factor of the potassium hydroxide solution is obtained from the amount of the potassium hydroxide solution required for neutralization when 25 mL of 0.1 mol/L hydrochloric acid is put in a conical flask, a few drops of the phenolphthalein solution are added to the hydrochloric acid, and the obtained product is titrated with the potassium hydroxide solution. As the 0.1 mol/L hydrochloric acid, hydrochloric acid prepared according to JIS K 8001-1998 is used.

### (2) Operation

### (A) Actual Test

2.0 g of a pulverized sample is accurately weighed into a 200 ml conical flask, 100 mL of a mixed solution of toluene/ethanol (2:1) is added to the pulverized sample, and the pulverized sample is dissolved into the mixed solution for 5 hours. Next, a few drops of the phenolphthalein solution are added as an indicator, and the resulting product is titrated using the potassium hydroxide solution. The end point of the titration is when thin red of the indicator continues for about 30 seconds.

### (B) Blank Test

Titration similar to that in the above operation is performed except that the sample is not used (i.e., only the mixed solution of toluene/ethanol (2:1) is used).

(3) the Obtained Results are Substituted into the Following Formula, Thereby Calculating the Acid Value.

$$A = [ ( C - B ) \times f \times 5.61 ] / S$$

In this formula, A represents the acid value (mgKOH/g), B represents the additive amount (mL) of the potassium hydroxide solution in the blank test, C represents the additive amount (mL) of the potassium hydroxide solution in the actual test, f represents the factor of the potassium hydroxide solution, and S represents the mass (g) of the sample.

### <Method for Measuring Carboxy Group Amount B of Fatty Acid on Surface of Barium Titanate Particles>

A carboxy group amount B (μmol/g) of the fatty acid on the surface of the barium titanate particles is measured similarly to the above method for measuring the acid value of a polyester. The unit (mgKOH/g) of the ultimately calculated acid value is converted to μmol/g, thereby obtaining the carboxy group amount B (μmol/g) of the fatty acid on the surface of the barium titanate particles.

<Measurement of Acid Value of Polyester from Toner>

As a method for measuring the acid value of a polyester from the toner, the following method can be used. The polyester is separated from the toner by the following method, and the acid value is measured.

The toner is dissolved into tetrahydrofuran (THF), and a solvent is distilled away from the obtained soluble fraction under reduced pressure, thereby obtaining a tetrahydrofuran (THF) soluble component of the toner.

The obtained tetrahydrofuran (THF) soluble component of the toner is dissolved into chloroform, thereby preparing a sample solution having a concentration of 25 mg/ml.

3.5 ml of the obtained sample solution is injected into the following apparatus, and a resin component having a molecular weight of 2000 or more is split off under the following conditions.

Preparative GPC apparatus: preparative HPLC LC-980 manufactured by Japan Analytical Industry Co., Ltd.

Preparative column: JAIGEL 3H, JAIGEL 5H (manufactured by Japan Analytical Industry Co., Ltd.)

Eluent: chloroform

Flow speed: 3.5 ml/min

After the resin-derived high-molecular-weight component is split off, a solvent is distilled away under reduced pressure, and the obtained product is further dried for 24 hours under reduced pressure in a 90° C. atmosphere. The above operation is repeated until about 2.0 g of the resin component is obtained.

The acid value is measured according to the above procedure using the obtained sample.

### <Measurements of Number Average Molecular Weights of Amorphous Polyester and Crystalline Polyester>

The number average molecular weights of the resins are measured as follows by gel permeation chromatography (GPC).

### (Amorphous Polyester)

First, the sample (the resin) is dissolved into tetrahydrofuran (THF) for 24 hours at room temperature. Then, the obtained solution is filtered through solvent-resistant membrane filter “Mai Shori Disk” (manufactured by Tosoh Corporation) having a pore diameter of 0.2 μm, thereby obtaining a sample solution. The sample solution is adjusted so that the concentration of a component soluble in a solvent is about 0.8 mass %. The number average molecular weight of the resin is measured using this sample solution under the following conditions.

Apparatus: HLC-8120GPC (detector: RI) (manufactured by Tosoh Corporation)

Column: seven-column string composed of Shodex KF-801, 802, 803, 804, 805, 806, and 807 (manufactured by Resonac Corporation)

Eluent: tetrahydrofuran (THF)

Flow speed: 1.0 ml/min

Oven temperature: 40.0° C.

Sample injection amount: 0.10 ml

The molecular weight of the sample is calculated using a molecular weight calibration curve created using standard polystyrene.

### (Crystalline Polyester)

First, the sample (the resin) is dissolved into hexafluoroisopropanol (HFIP) for 24 hours at room temperature. Then, the obtained solution is filtered through solvent-resistant membrane filter “Mai Shori Disk” (manufactured by Tosoh Corporation) having a pore diameter of 0.2 μm, thereby obtaining a sample solution. The sample solution is adjusted so that the concentration of a component soluble in a solvent is about 0.8 mass %. The number average molecular weight of the resin is measured using this sample solution under the following conditions.

Apparatus: HLC-8120GPC (detector: RI) (manufactured by Tosoh Corporation)

Column: seven-column string composed of Shodex KF-801, 802, 803, 804, 805, 806, and 807 (manufactured by Resonac Corporation)

Eluent: hexafluoroisopropanol (HFIP)

Flow speed: 1.0 mL/min

Oven temperature: 40.0° C.

Sample injection amount: 0.10 mL

The molecular weight of the sample is calculated using a molecular weight calibration curve created using a standard polymethyl methacrylate resin.

### <Method for Measuring Weight Average Particle Diameter (D4) of Toner Particles>

The weight average particle diameter (D4) of the toner particles is calculated by measuring the toner particles in 25000 channels as the number of effective measurement channels through the use of precise particle size distribution measurement apparatus “Coulter Counter Multisizer 3” (registered trademark, manufactured by Beckman Coulter, Inc.) using resistive pulse sensing including a 100 μm aperture tube, and accompanying dedicated software “Beckman Coulter Multisizer 3 Version 3.51” (manufactured by Beckman Coulter, Inc.) for setting measurement conditions and analyzing measurement data, and by analyzing the measurement data.

As an electrolyte aqueous solution used in the measurement, an electrolyte aqueous solution obtained by dissolving special grade sodium chloride into ion-exchanged water so that the concentration is about 1 mass %, such as “ISOTON II” (manufactured by Beckman Coulter, Inc.), can be used.

Before the measurement and the analysis are made, the dedicated software is set as follows.

On a “change standard measurement method (SOM)” screen of the dedicated software, the total number of counts of a control mode is set to 50000 particles, the number of measurements is set to 1, and a Kd value is set to a value obtained using “standard particles of 10.0 μm” (manufactured by Beckman Coulter, Inc.) is set. A measurement button for “threshold/noise level” is pressed, thereby automatically setting a threshold and a noise level. Current is set to 1600 μA, gain is set to 2, an electrolyte solution is set to ISOTON II, and the flash of the aperture tube after the measurement is checked.

On a “set conversion from pulse to particle diameter” screen of the dedicated software, the bin interval is set to a logarithmic particle diameter, the particle diameter bins are set to 256 particle diameter bins, and the particle diameter range is set to 2 μm or more and 60 μm or less.

A specific measurement method is as follows.
(1) About 200 ml of the above electrolyte aqueous solution is put in a glass 250 ml round-bottom beaker dedicated to Multisizer 3, the beaker is set in a sample stand, the electrolyte aqueous solution is agitated using a stirrer rod counterclockwise at 24 revolutions/second. Then, dirt and air bubbles in the aperture tube are removed by a “flash of aperture tube” function of the dedicated software.
(2) About 30 ml of the above electrolyte aqueous solution is put in a glass 100 ml flat-bottom beaker, and about 0.3 ml of a diluted solution obtained by diluting “Contaminon N” (a 10 mass % aqueous solution of a precise measuring device washing neutral detergent having a pH of 7 composed of a non-ionic surfactant, an anionic surfactant, and an organic builder, manufactured by FUJIFILM Wako Pure Chemical Corporation) with 3 times the mass of ion-exchanged water is added as a dispersant into the electrolyte aqueous solution.
(3) A predetermined amount of ion-exchanged water is put in a tank of ultrasonic disperser “Ultrasonic Dispersion System Tetora 150” (manufactured by Nikkaki Bios Co., Ltd.) having two oscillators with an oscillation frequency of 50 kHz built-in in the state where the phases of the two oscillators are shifted by 180 degrees, and having an electrical output of 120 W, and about 2 ml of the Contaminon N is added into the tank.
(4) The beaker in the above (2) is set in a beaker fixing hole of the ultrasonic disperser, and the ultrasonic disperser is caused to operate. Then, the height position of the beaker is adjusted to maximize the resonance state of the liquid surface of the electrolyte aqueous solution in the beaker.
(5) In the state where the electrolyte aqueous solution in the beaker in the above (4) is irradiated with an ultrasonic wave, about 10 mg of the toner is added in small batches to the electrolyte aqueous solution and dispersed into the electrolyte aqueous solution. Then, the ultrasonic dispersion process is continued for 60 more seconds. In the ultrasonic dispersion, the water temperature of the tank is appropriately adjusted to 10° C. or more and 40° C. or less.
(6) The electrolyte aqueous solution in the above (5) in which the toner is dispersed using a pipette is dripped into the round-bottom beaker in the above (1) set in the sample stand, and the obtained product is adjusted so that the measured concentration is about 5%. Then, the measurement is made until the number of measured particles is 50000.
(7) The measurement data is analyzed using the dedicated software accompanying the apparatus, and the weight average particle diameter (D4) is calculated. “Average diameter” on an “analysis/volume statistical value (arithmetic average)” screen when “graph/volume %” is set in the dedicated software is the weight average particle diameter (D4).

### EXAMPLES

The present disclosure is more specifically described using the following examples. These examples, however, do not limit the present disclosure in any way. “Parts” in the following prescriptions are all on a mass basis, unless otherwise noted.

### <Example of Manufacturing of Barium Titanate Particles 1>

### (1) Reaction Preparation Step

A sodium hydroxide aqueous solution was added to a metatitanic acid dispersion liquid, thereby obtaining a pH of 9.0. After the obtained solution was subjected to a desulfurization process, hydrochloric acid was added to the solution, thereby adjusting the solution to a pH of 5.7. Next, after the solution adjusted to a pH of 5.7 was filtered, and the obtained solid content was washed with water, ion-exchanged water was added to the solid content washed with water, thereby obtaining a slurry having a Ti concentration of 2.12 mol/L. Hydrochloric acid was added to the obtained slurry, and a peptization process was performed on the slurry. Next, 2.1590 mol of a barium chloride aqueous solution in terms of Ba was input to the slurry after the peptization process.

### (2) Reaction Step

After the internal temperature of a reaction container was raised to 90° C. while the slurry obtained by above procedure was agitated, 550 mL of a sodium hydroxide aqueous solution (10 mol/L) was added to the reaction container for 2 hours at a constant speed. Next, the internal temperature of the reaction container was raised to 90° C., and the obtained solution was agitated for 2 hours in the state where the internal temperature was maintained at 90° C. Next, after the content of the container was cooled to 50° C., hydrochloric acid was added to the content of the container until a pH of 5.0 was obtained. Next, the obtained product was agitated for 1 hour in the state where the product was maintained at 50° C., thereby obtaining a precipitate.

After the obtained precipitate was washed by decantation and filtered, the obtained solid content was dried for 10 hours in the atmosphere at a temperature of 90° C., thereby obtaining a powder of a barium titanate core A.

### (3) Fatty Acid Surface Treatment Step

The following materials were input to a Henschel mixer.
Barium titanate core: 100.00 parts
Stearic acid (carbon number 18): 4.12 parts

After the obtained product was agitated for 2 minutes at 2000 rpm, the product was agitated for 10 minutes at 100 rpm while the temperature was raised to 90° C., thereby obtaining barium titanate particles 1. Table 1 illustrates the physical properties of the barium titanate particles 1.

### <Example of Manufacturing of Barium Titanate Particles 2>

Barium titanate particles 2 having physical properties illustrated in table 1 were obtained similarly to the example of the manufacturing of the barium titanate particles 1 except that in the fatty acid surface treatment step, the additive amount of the stearic acid was changed to 1.02 parts.

### <Example of Manufacturing of Barium Titanate Particles 3>

Barium titanate particles 3 having physical properties illustrated in table 1 were obtained similarly to the example of the manufacturing of the barium titanate particles 1 except that in the fatty acid surface treatment step, the additive amount of the stearic acid was changed to 0.90 parts.

### <Example of Manufacturing of Barium Titanate Particles 4>

Barium titanate particles 4 having physical properties illustrated in table 1 were obtained similarly to the example of the manufacturing of the barium titanate particles 1 except that in the fatty acid surface treatment step, the additive amount of the stearic acid was changed to 0.50 parts.

### <Example of Manufacturing of Barium Titanate Particles 5>

Barium titanate particles 5 having physical properties illustrated in table 1 were obtained similarly to the example of the manufacturing of the barium titanate particles 1 except that in the fatty acid surface treatment step, the additive amount of the stearic acid was changed to 5.00 parts.

### <Example of Manufacturing of Barium Titanate Particles 6>

Barium titanate particles 6 having physical properties illustrated in table 1 were obtained similarly to the example of the manufacturing of the barium titanate particles 1 except that in the fatty acid surface treatment step, the stearic acid was changed to lauric acid (carbon number 12).

### <Example of Manufacturing of Barium Titanate Particles 7>

Barium titanate particles 7 having physical properties illustrated in table 1 were obtained similarly to the example of the manufacturing of the barium titanate particles 1 except that in the fatty acid surface treatment step, the stearic acid was changed to lignoceric acid (carbon number 24).

### <Example of Manufacturing of Barium Titanate Particles 8>

Barium titanate particles 8 having physical properties illustrated in table 1 were obtained similarly to the example of the manufacturing of the barium titanate particles 1 except that in the fatty acid surface treatment step, the stearic acid was changed to capric acid (carbon number 10).

### <Example of Manufacturing of Barium Titanate Particles 9>

Barium titanate particles 9 having physical properties illustrated in table 1 were obtained similarly to the example of the manufacturing of the barium titanate particles 1 except that in the fatty acid surface treatment step, the stearic acid was changed to cerotic acid (carbon number 26).

### <Example of Manufacturing of Barium Titanate Particles 10>

Barium titanate particles 10 having physical properties illustrated in table 1 were obtained similarly to the example of the manufacturing of the barium titanate particles 1 except that in the fatty acid surface treatment step, the additive amount of the stearic acid was changed to 4.84 parts.

### <Example of Manufacturing of Barium Titanate Particles 11>

Barium titanate particles 11 having physical properties illustrated in table 1 were obtained similarly to the example of the manufacturing of the barium titanate particles 1 except that in the fatty acid surface treatment step, the additive amount of the stearic acid was changed to 3.51 parts.

### <Example of Manufacturing of Barium Titanate Particles 12>

Barium titanate particles 12 having physical properties illustrated in table 1 were obtained similarly to the example of the manufacturing of the barium titanate particles 1 except that in the fatty acid surface treatment step, the additive amount of the stearic acid was changed to 4.92 parts.

### <Example of Manufacturing of Barium Titanate Particles 13>

Barium titanate particles 13 having physical properties illustrated in table 1 were obtained similarly to the example of the manufacturing of the barium titanate particles 1 except that in the fatty acid surface treatment step, the additive amount of the stearic acid was changed to 3.31 parts.

### <Example of Manufacturing of Barium Titanate Particles 14>

Barium titanate particles 14 having physical properties illustrated in table 1 were obtained similarly to the example of the manufacturing of the barium titanate particles 1 except that in the reaction step, time spent on the addition of the sodium hydroxide aqueous solution was changed to 1 hour.

### <Example of Manufacturing of Barium Titanate Particles 15>

Barium titanate particles 15 having physical properties illustrated in table 1 were obtained similarly to the example of the manufacturing of the barium titanate particles 1 except that in the reaction step, time spent on the addition of the sodium hydroxide aqueous solution was changed to 2 hours and 30 minutes.

### <Example of Manufacturing of Barium Titanate Particles 16>

Barium titanate particles 16 having physical properties illustrated in table 1 were obtained similarly to the example of the manufacturing of the barium titanate particles 1 except that in the reaction step, time spent on the addition of the sodium hydroxide aqueous solution was changed to 30 minutes.

### <Example of Manufacturing of Barium Titanate Particles 17>

Barium titanate particles 17 having physical properties illustrated in table 1 were obtained similarly to the example of the manufacturing of the barium titanate particles 1 except that in the reaction step, time spent on the addition of the sodium hydroxide aqueous solution was changed to 3 hours.

### <Example of Manufacturing of Barium Titanate Particles 18>

Barium titanate particles 18 having physical properties illustrated in table 1 were obtained similarly to the example of the manufacturing of the barium titanate particles 1 except that in the fatty acid surface treatment step, the additive amount of the stearic acid was changed to 5.26 parts.

### <Example of Manufacturing of Barium Titanate Particles 19>

Barium titanate particles 19 having physical properties illustrated in table 1 were obtained similarly to the example of the manufacturing of the barium titanate particles 1 except that in the fatty acid surface treatment step, the additive amount of the stearic acid was changed to 0.10 parts.

### <Example of Manufacturing of Barium Titanate Particles 20>

Barium titanate particles 20 having physical properties illustrated in table 1 were obtained similarly to the example of the manufacturing of the barium titanate particles 1 except that in the fatty acid surface treatment step, the stearic acid was changed to caproic acid (carbon number 6).

### <Example of Manufacturing of Barium Titanate Particles 21>

Barium titanate particles 21 having physical properties illustrated in table 1 were obtained similarly to the example of the manufacturing of the barium titanate particles 1 except that the fatty acid surface treatment step was eliminated.

### <Example of Manufacturing of Barium Titanate Particles 22>

Barium titanate particles 22 having physical properties illustrated in table 1 were obtained similarly to the example of the manufacturing of the barium titanate particles 1 except that in the fatty acid surface treatment step, the stearic acid was changed to pentanoic acid (carbon number 5).

### <Example of Manufacturing of Barium Titanate Particles 23>

Barium titanate particles 23 having physical properties illustrated in table 1 were obtained similarly to the example of the manufacturing of the barium titanate particles 1 except that in the fatty acid surface treatment step, the additive amount of the stearic acid was changed to 5.30 parts.

### <Example of Manufacturing of Barium Titanate Particles 24>

Barium titanate particles 24 having physical properties illustrated in table 1 were obtained similarly to the example of the manufacturing of the barium titanate particles 1 except that in the fatty acid surface treatment step, the additive amount of the stearic acid was changed to 0.05 parts.

### <Example of Manufacturing of Barium Titanate Particles 25>

285 parts of barium hydroxide octahydrate as a reagent were added to 600 parts of pure water, and the obtained product was heated while being agitated, thereby preparing an aqueous solution at 80° C. (a liquid A).

560 parts of n-butanol and 220 parts of tetra-n-butoxytitanium as a reagent were prepared in another reaction container, and the obtained product was hydrolyzed by gradually adding 200 parts of pure water while being agitated, thereby preparing a titanium hydroxide slurry at 25° C. (a liquid B).

The liquid A was rapidly added to the liquid B, and the obtained product was heated to 90° C. at a temperature rising speed of 30° C. per hour while being refluxed, and further was matured for 1 hour at 90° C.

After the product was cooled, the product was filtered by suction, thereby obtaining a cake of deposited crystals. After 300 parts of a 3% acetic acid aqueous solution were added to the cake obtained by separation, and the washing and the filtration of the obtained product were repeated twice, the obtained cake was dried for 24 hours at 105° C., thereby obtaining a barium titanate precursor powder.

After the barium titanate precursor powder was crushed using a roll mill, the crushed barium titanate precursor powder was calcined for 4 hours at 850° C. A sample was obtained by removing aggregated particles using a jet mill.

Next, a fatty acid surface treatment step similar to that in the example of the manufacturing of the barium titanate particles 1 was performed on 100.00 parts of the above sample using 4.10 parts of the stearic acid, thereby obtaining barium titanate particles. Table 1 illustrates the composition and the physical properties of the obtained barium titanate particles as barium titanate particles 25.

### <Example of Manufacturing of Barium Titanate Particles 26>

In a nitrogen atmosphere, 75 parts of barium isopropoxide and 92 parts of titanium tetraisopropoxide were dissolved into 275 parts of isopropyl alcohol, and the obtained product was heated to reflux for 2 hours. Next, while the heating reflux was continued, 65 parts of distilled water were dripped into this solution for 1 hour, thereby hydrolyzing the isopropoxide. After the obtained product was cooled to 25° C., the product was adjusted by adding water so that the slurry concentration was 0.5 mol/L in terms of barium titanate. After the temperature of this slurry was raised to the boiling temperature for 1 hour, the slurry was heated to reflux for 3 hours. After the obtained product was cooled to 25° C., the product was washed with water by repeating decantation, then filtered, washed with water, dried at 105° C., and crushed, thereby obtaining barium titanate particles. Table 1 illustrates the composition and the physical properties of the obtained barium titanate particles as barium titanate particles 26.

### <Example of Manufacturing of Strontium Titanate Particles 1>

After metatitanic acid manufactured using a sulfuric acid method was subjected to a deironization bleaching process, a 3 mol/L sodium hydroxide aqueous solution was added to the obtained product, thereby obtaining a pH of 9.0. Then, the obtained solution was subjected to a desulfurization process, then neutralized to a pH of 5.6 using 5 mol/L hydrochloric acid, and filtered and washed with water. Water was added to the washed cake, thereby obtaining 1.90 mol/L of a titanium dioxide (TiO₂) slurry. Then, hydrochloric acid was added to the obtained slurry, thereby obtaining a pH of 1.4. Then, a peptization process was performed on the slurry.

1.90 mol of the desulfurized and peptized metatitanic acid was collected as TiO₂ and input to a 3 L reaction container. After 2.185 mol of a strontium chloride aqueous solution was added to the peptized metatitanic acid slurry so that SrO/TiO₂ (a mol ratio) was 1.15, the obtained product was adjusted to a TiO₂ concentration of 1.039 mol/L.

Next, after the obtained product was warmed to 90° C. while being agitated and mixed, 440 mL of a 10 mol/L sodium hydroxide aqueous solution was added to the product for 40 minutes. Then, after the obtained product continued to be agitated for 45 minutes at 95° C., the product was input to ice water and rapidly cooled, thereby ending the reaction.

The reaction slurry was heated to 70° C., 12 mol/L hydrochloric acid was added to the reaction slurry, the obtained product continued to be agitated for 1 hour until a pH of 5.0 was obtained, and the obtained precipitate was decanted.

The slurry including the obtained precipitate was adjusted to 40° C., and hydrochloric acid was added to the slurry, thereby adjusting the slurry to a pH of 2.5. Then, 4.0 mass % 3,3,3-trifluoropropyltrimethoxysilane relative to the solid content was added as a surface treatment agent 1, 4.0 mass % isobutyltrimethoxysilane relative to the solid content was added as a surface treatment agent 2, and the obtained product was agitated for 10 hours. After the product was adjusted to a pH of 6.5 by adding a 5 mol/L sodium hydroxide aqueous solution, the obtained product continued to be agitated for 1 hour and then was filtered and washed. The obtained cake was dried for 8 hours in the atmosphere at 120° C., thereby obtaining strontium titanate particles 1. The number average particle diameter of the primary particles of the obtained strontium titanate particles 1 was 40 nm.

### <Example of Manufacturing of Calcium Titanate Particles 1>

Titanium tetraisopropoxide as a raw material was sent into glass wool of a vaporizer heated to about 200° C., using nitrogen gas as carrier gas in small batches with a chemical pump, and was evaporated. After the titanium tetraisopropoxide was instantaneously heated to decompose at about 300° C. in a reactor, the resulting product was rapidly cooled and collected. The collected product was further fired for about 2 hours at about 300° C. and pulverized using a jet mill, thereby obtaining titanium oxide.

52 parts of the above titanium oxide and 48 parts of calcium carbonate were dispersed into 100 parts of water, and the obtained product was mixed until well-mixed, and was subjected to heat treatment at a temperature of about 1000° C., thereby obtaining calcium titanate particles 1. The number average particle diameter of the primary particles of the obtained calcium titanate particles 1 was 40 nm.

TABLE 1

| | Surface Treatment | | Number | | | |
|---|---|---|---|---|---|---|
| Barium | Fatty Acid | | Average | Hydroxy | Carboxy | |
| Titanate | | Additive | Particle | Group | Group | |
| Particles | | Amount | Diameter | Amount A | Amount B | Ratio |
| No. | Type | (Parts) | (μm) | (μmol/g) | (μmol/g) | A/B |
| 1 | Stearic | 4.12 | 0.10 | 300 | 150.6 | 2.0 |
| | acid | | | | | |
| 2 | Stearic | 1.02 | 0.10 | 1070 | 36.2 | 29.5 |
| | acid | | | | | |
| 3 | Stearic | 0.90 | 0.10 | 1100 | 31.9 | 34.5 |
| | acid | | | | | |
| 4 | Stearic | 0.50 | 0.10 | 1200 | 17.6 | 68.1 |
| | acid | | | | | |
| 5 | Stearic | 5.00 | 0.10 | 80 | 184.7 | 0.4 |
| | acid | | | | | |
| 6 | Lauric acid | 4.12 | 0.10 | 300 | 214.6 | 1.4 |
| 7 | Lignoceric | 4.12 | 0.10 | 300 | 116.3 | 2.6 |
| | acid | | | | | |
| 8 | Capric | 4.12 | 0.10 | 300 | 249.6 | 1.2 |
| | acid | | | | | |
| 9 | Cerotic | 4.12 | 0.10 | 300 | 108.1 | 2.8 |
| | acid | | | | | |
| 10 | Stearic | 4.84 | 0.10 | 120 | 178.4 | 0.7 |
| | acid | | | | | |
| 11 | Stearic | 3.51 | 0.10 | 450 | 127.8 | 3.5 |
| | acid | | | | | |
| 12 | Stearic | 4.92 | 0.10 | 100 | 181.6 | 0.6 |
| | acid | | | | | |
| 13 | Stearic | 3.31 | 0.10 | 500 | 120.2 | 4.2 |
| | acid | | | | | |
| 14 | Stearic | 4.12 | 0.02 | 300 | 150.6 | 2.0 |
| | acid | | | | | |
| 15 | Stearic | 4.12 | 0.12 | 300 | 150.6 | 2.0 |
| | acid | | | | | |
| 16 | Stearic | 4.12 | 0.01 | 300 | 150.6 | 2.0 |
| | acid | | | | | |
| 17 | Stearic | 4.12 | 0.15 | 300 | 150.6 | 2.0 |
| | acid | | | | | |
| 18 | Stearic | 5.26 | 0.10 | 15 | 194.9 | 0.1 |
| | acid | | | | | |
| 19 | Stearic | 0.10 | 0.10 | 1300 | 3.4 | 382.4 |
| | acid | | | | | |
| 20 | Caproic | 4.12 | 0.10 | 300 | 370.1 | 0.8 |
| | acid | | | | | |
| 21 | — | — | 0.10 | 300 | 0 | — |
| 22 | Pentanoic | 4.12 | 0.10 | 300 | 150.6 | 2.0 |
| | acid | | | | | |
| 23 | Stearic | 5.30 | 0.10 | 5 | 636.1 | 0.0 |
| | acid | | | | | |
| 24 | Stearic | 0.05 | 0.10 | 1500 | 4.3 | 348.8 |
| | acid | | | | | |
| 25 | Stearic | 4.10 | 0.10 | 0 | 368.6 | — |
| | acid | | | | | |
| 26 | — | — | 0.10 | 100 | 0 | — |

### <Example of Manufacturing of Amorphous Polyester 1>

Polyoxypropylene (2.2)-2,2-bis(4-hydroxyphenyl) propane: 71.3 parts (0.155 mol parts)
Terephthalic acid: 24.1 parts (0.145 mol parts)
Titanium tetrabutoxide: 0.6 parts

The above materials were put in a glass 4-liter four-neck flask. Then, a thermometer, an agitation rod, a capacitor, and a nitrogen introduction tube were attached to the flask, and the flask was placed in a heating mantle. Next, after the inside of the flask was substituted with nitrogen gas, the temperature was gradually raised while the obtained product was agitated. Then, the product was caused to react for 2 hours while being agitated at a temperature of 200° C. Then, 5.8 parts (0.030 mol parts) of trimellitic anhydride were added to the product, and the obtained product was caused to react for 10 hours at 180° C., thereby obtaining an amorphous polyester 1. The number average molecular weight of the amorphous polyester 1 was 6000, and the acid value of the amorphous polyester 1 was 10 mgKOH/g.

### <Example of Manufacturing of Amorphous Polyester 2>

Polyoxypropylene (2.2)-2,2-bis(4-hydroxyphenyl) propane: 96.6 parts (0.210 mol parts)
Terephthalic acid: 24.1 parts (0.145 mol parts)
Titanium tetrabutoxide: 0.6 parts

The above materials were put in a glass 4-liter four-neck flask, a thermometer, an agitation rod, a capacitor, and a nitrogen introduction tube were attached to the flask, and the flask was placed in a heating mantle. Next, after the inside of the flask was substituted with nitrogen gas, the temperature was gradually raised while the obtained product was agitated. Then, the product was caused to react for 2 hours while being agitated at a temperature of 200° C., and further was caused to react for 10 hours at 180° C., thereby obtaining an amorphous polyester 2. The number average molecular weight of the amorphous polyester 2 was 3000, and the acid value of the amorphous polyester 2 was 5 mgKOH/g.

### <Example of Manufacturing of Amorphous Polyester 3>

An amorphous polyester 3 was obtained by performing reactions similarly except that in the example of the manufacturing of the amorphous polyester 1, the additive amount of the polyoxypropylene (2.2)-2,2-bis(4-hydroxyphenyl) propane was changed to 76.9 parts, the additive amount of the titanium tetrabutoxide was changed to 0.5 parts, and the additive amount of the trimellitic anhydride was changed to 5.3 parts. The number average molecular weight of the amorphous polyester 3 was 4500, and the acid value of the amorphous polyester 3 was 30 mgKOH/g.

### <Example of Manufacturing of Amorphous Polyester 4>

Polyoxypropylene (2.2)-2,2-bis(4-hydroxyphenyl) propane: 60.0 parts
Terephthalic acid: 35.0 parts
Titanium tetrabutoxide (esterification catalyst): 0.5 parts

The above materials were put in a glass 4-liter four-neck flask. Then, a thermometer, an agitation rod, a capacitor, and a nitrogen introduction tube were attached to the flask, and the flask was placed in a heating mantle. Next, after the inside of the flask was substituted with nitrogen gas, the temperature was gradually raised while the obtained product was agitated. Then, the product was caused to react for 2 hours while being agitated at a temperature of 200° C. Further, after the pressure inside the reaction tank was decreased to 8.3 kPa and maintained for 1 hour, the product was cooled to 160° C., and the pressure inside the reaction tank was returned to the atmosphere.
Stearic acid: 5.0 parts

Then, the above material was added, the pressure inside the reaction tank was decreased to 8.3 kPa, and the obtained product was caused to react for 2 hours while the temperature was maintained at 200° C. Then, the temperature was lowered, and the reaction was stopped, thereby obtaining an amorphous polyester 4. The number average molecular weight of the amorphous polyester 4 was 3100, and the acid value of the amorphous polyester 4 was 10 mgKOH/g.

### <Example of Manufacturing of Amorphous Polyester 5>

An amorphous polyester 5 not including a carboxy group was obtained by performing reactions similarly except that in the example of the manufacturing of the amorphous polyester 1, the additive amount of the polyoxypropylene (2.2)-2,2-bis(4-hydroxyphenyl) propane was changed to 96.6 parts, the additive amount of the terephthalic acid was changed to 18.0 parts, the additive amount of the trimellitic anhydride was changed to 6.0 parts, and the titanium tetrabutoxide was not used. The number average molecular weight of the amorphous polyester 5 was 6200, and the acid value of the amorphous polyester 5 was 0 mgKOH/g.

### <Example of Manufacturing of Styrene Acrylic Resin 1>

After 850 parts of xylene were put in a glass 2-liter four-neck flask equipped with a thermometer, a stainless-steel agitation rod, a falling film condenser, and a nitrogen introduction tube and substituted with nitrogen, the temperature was raised to 150° C.
Styrene: 800 parts
n-butyl acrylate: 1000 parts
Monobutyl acrylate: 50 parts
Dicumyl peroxide: 80 parts

Then, a mixture of the above materials was dripped using a dropping funnel for 4 hours and caused to react for 4 hours at 150° C. Then, the temperature was raised to 200° C., and xylene was distilled away under reduced pressure, thereby obtaining a styrene acrylic resin 1. The acid value of the styrene acrylic resin 1 was 0 mgKOH/g.

### <Example of Manufacturing of Crystalline Polyester 1>

Ethylene glycol: 22.0 parts
Dodecanedioic acid: 68.0 parts
Behenic acid: 10.0 parts
2-ethylhexanoate: 0.5 parts

The above materials were weighed into a reaction tank including a cooling tube, an agitation machine, a nitrogen introduction tube, and a thermocouple.

After the inside of this flask was substituted with nitrogen gas, the temperature was gradually raised while the obtained product was agitated. Then, the product was caused to react for 3 hours while being agitated at a temperature of 140° C.

Then, the pressure inside the reaction tank was decreased to 8.3 kPa, and while the temperature inside the reaction tank was maintained at 200° C. under a pressure of 8.3 kPa, the product was caused to react for 4 hours, thereby obtaining a crystalline polyester 1. Table 2 illustrates the physical properties of the crystalline polyester 1.

### <Examples of Manufacturing of Crystalline Polyesters 2 to 8>

Crystalline Polyesters 2 to 8 were obtained by performing reactions similarly except that in the example of the manufacturing of the crystalline polyester 1, the monomers to be used were changed as illustrated in table 2. Table 2 illustrates the physical properties of the obtained crystalline polyesters 2 to 8.

TABLE 2

| | | | Dicarboxylic Acid | | Monoalcohol/ | | |
|---|---|---|---|---|---|---|---|
| | Diol Component | | Component | | Monocarboxylic Acid | | Number |
| Crystalline | | Number | | Number | Component | | Average |
| Resin | | of | | of | | Number | Molecular |
| No. | Type | Parts | Type | Parts | Type | of Parts | Weight |
| 1 | Ethylene | 22.0 | Dodecanedioic | 68.0 | Behenic | 10.0 | 4900 |
| | glycol | | acid | | acid | | |
| 2 | Ethylene | 22.0 | Dodecanedioic | 68.0 | Stearic acid | 10.0 | 4800 |
| | glycol | | acid | | | | |
| 3 | Ethylene | 22.0 | Dodecanedioic | 68.0 | Behenyl | 10.0 | 4900 |
| | glycol | | acid | | alcohol | | |
| 4 | Ethylene | 18.0 | Dodecanedioic | 82.0 | — | — | 4800 |
| | glycol | | acid | | | | |
| 5 | Ethylene | 23.0 | Tetradecanedioic | 68.0 | Behenic | 10.0 | 5000 |
| | glycol | | acid | | acid | | |
| 6 | Ethylene | 24.0 | Hexadecanedioic | 68.0 | Behenic | 10.0 | 4900 |
| | glycol | | acid | | acid | | |
| 7 | Butanediol | 30.0 | Dodecanedioic | 45.0 | Behenic | 10.0 | 5000 |
| | | | acid | | acid | | |
| 8 | Hexane | 45.0 | Dodecanedioic | 67.0 | Behenic | 10.0 | 5100 |
| | diol | | acid | | acid | | |

### <Example of Manufacturing of Toner Particles 1>

| | | |
|---|---|---|
| Amorphous polyester 1 | 100.0 | parts |
| crystalline polyester 1 | 6.0 | parts |
| Fischer-Tropsch wax | 5.0 | parts |
| (peak temperature of 78° C. | | |
| at maximum endothermic peak) | | |
| C.I. Pigment Blue 15:3 | 5.0 | parts |

After the raw materials indicated in the above prescription were mixed at a number of revolutions of 20 s⁻¹ for a rotation time of 5 minutes using a Henschel mixer (FM-75, manufactured by Nippon Coke & Engineering Co., Ltd.), the obtained product was kneaded using a biaxial kneader (PCM-30, manufactured by Ikegai Corp.) set to a temperature of 125° C. and a number of revolutions of 300 rpm. The obtained kneaded product was cooled and coarsely pulverized to a diameter of 1 mm or less using a hammer mill, thereby obtaining a coarsely pulverized product. The obtained coarsely pulverized product was finely pulverized using a mechanical pulverizer (T-250, manufactured by Freund-Turbo Corporation). Further, the obtained product was classified using a rotary classifier (200TSP manufactured by Hosokawa Micron Corporation), thereby obtaining toner particles 1. The rotary classifier (200TSP manufactured by Hosokawa Micron Corporation) performed the classification under the driving conditions of a number of classification rotor revolutions of 50.0 s⁻¹. The weight average particle diameter (D4) of the obtained toner particles 1 was 5.9 μm.

### <Examples of Manufacturing of Toner Particles 2 to 9>

Toner particles 2 to 9 were obtained similarly except that in the example of the manufacturing of the toner particles 1, the type of the crystalline polyesters was changed as illustrated in table 3.

### <Examples of Manufacturing of Toner Particles 10 to 13>

Toner particles 10 to 13 were obtained similarly except that in the example of the manufacturing of the toner particles 1, the type of the amorphous polyesters was changed as illustrated in table 3.

### <Example of Manufacturing of Toner Particles 14>

Toner particles 14 were obtained similarly except that in the example of the manufacturing of the toner particles 1, 100 parts of the styrene acrylic resin 1 were used instead of the amorphous polyester.

TABLE 3

| | Crystalline Polyester | | Amorphous Polyester | | Weight |
|---|---|---|---|---|---|
| Toner | | Additive | | Additive | Average |
| Parti- | | Amount | | Amount | Particle |
| cles | | (Number | | (Number | Diameter |
| No. | No. | of Parts) | No. | of Parts) | (μm) |
| 1 | Crystalline | 6.0 | Amorphous | 100.0 | 5.9 |
| | polyester 1 | | polyester 1 | | |
| 2 | Crystalline | 6.0 | Amorphous | 100.0 | 5.9 |
| | polyester 2 | | polyester 1 | | |
| 3 | Crystalline | 6.0 | Amorphous | 100.0 | 5.9 |
| | polyester 3 | | polyester 1 | | |
| 4 | Crystalline | 6.0 | Amorphous | 100.0 | 5.9 |
| | polyester 4 | | polyester 1 | | |
| 5 | — | — | Amorphous | 100.0 | 5.9 |
| | | | polyester 1 | | |
| 6 | Crystalline | 6.0 | Amorphous | 100.0 | 5.9 |
| | polyester 5 | | polyester 1 | | |
| 7 | Crystalline | 6.0 | Amorphous | 100.0 | 5.9 |
| | polyester 6 | | polyester 1 | | |
| 8 | Crystalline | 6.0 | Amorphous | 100.0 | 5.9 |
| | polyester 7 | | polyester 1 | | |
| 9 | Crystalline | 6.0 | Amorphous | 100.0 | 5.9 |
| | polyester 8 | | polyester 1 | | |
| 10 | Crystalline | 6.0 | Amorphous | 100.0 | 5.9 |
| | polyester 1 | | polyester 2 | | |
| 11 | Crystalline | 6.0 | Amorphous | 100.0 | 5.9 |
| | polyester 1 | | polyester 3 | | |
| 12 | Crystalline | 6.0 | Amorphous | 100.0 | 5.9 |
| | polyester 1 | | polyester 4 | | |
| 13 | Crystalline | 6.0 | Amorphous | 100.0 | 5.9 |
| | polyester 1 | | polyester 5 | | |
| 14 | Crystalline | 6.0 | — | — | 5.9 |
| | polyester 1 | | | | |

* In the toner particles 14, a styrene acrylic resin was used instead of the amorphous polyester.

### <Example of Manufacturing of Toner 1>

| | | |
|---|---|---|
| Toner | 100.00 | parts |
| particles 1 | | |
| Barium titanate | 1.50 | parts |
| particles 1 | | |
| Strontium titanate | 0.40 | parts |

particles 1

The above materials were mixed at a number of revolutions 30 s⁻¹ for a rotation time of 10 min using Henschel mixer FM-10C (manufactured by Mitsui Miike Machinery Company, Limited), thereby obtaining toner 1.

### <Examples of Manufacturing of Toner 2 and 3>

Toner 2 and 3 was obtained by performing manufacturing similarly except that in the example of the manufacturing of the toner 1, the type of the barium titanate particles was changed as illustrated in table 4.

### <Example of Manufacturing of Toner 4>

Toner 4 was obtained by performing manufacturing similarly except that in the example of the manufacturing of the toner 1, the strontium titanate particles 1 were changed to the calcium titanate particles 1.

### <Example of Manufacturing of Toner 5>

Toner 5 was obtained by performing manufacturing similarly except that in the example of the manufacturing of the toner 1, the strontium titanate was not added.

### <Examples of Manufacturing of Toner 6 to 48>

Toner 6 to 48 was obtained by performing manufacturing similarly except that in the example of the manufacturing of the toner 1, the type of the toner particles and the type and the additive amount of the barium titanate particles were changed as illustrated in table 4.

TABLE 4

| | | Barium Titanate | | | |
|---|---|---|---|---|---|
| | | Particles | | Other External Additives | |
| | Toner | | Additive | | Additive |
| Toner | Particles | | Amount | | Amount |
| No. | No. | No. | (Parts) | No. | (Parts) |
| 1 | 1 | 1 | 1.50 | Strontium titanate | 0.40 |
| | | | | particles 1 | |
| 2 | 1 | 2 | 1.50 | Strontium titanate | 0.40 |
| | | | | particles 1 | |
| 3 | 1 | 3 | 1.50 | Strontium titanate | 0.40 |
| | | | | particles 1 | |
| 4 | 1 | 1 | 1.50 | Calcium titanate | 0.40 |
| | | | | particles 1 | |
| 5 | 1 | 1 | 1.50 | — | — |
| 6 | 1 | 4 | 1.50 | Strontium titanate | 0.40 |
| | | | | particles 1 | |
| 7 | 1 | 5 | 1.50 | Strontium titanate | 0.40 |
| | | | | particles 1 | |
| 8 | 2 | 1 | 1.50 | Strontium titanate | 0.40 |
| | | | | particles 1 | |
| 9 | 3 | 1 | 1.50 | Strontium titanate | 0.40 |
| | | | | particles 1 | |
| 10 | 4 | 1 | 1.50 | Strontium titanate | 0.40 |
| | | | | particles 1 | |
| 11 | 5 | 1 | 1.50 | Strontium titanate | 0.40 |
| | | | | particles 1 | |
| 12 | 6 | 1 | 1.50 | Strontium titanate | 0.40 |
| | | | | particles 1 | |
| 13 | 7 | 1 | 1.50 | Strontium titanate | 0.40 |
| | | | | particles 1 | |
| 14 | 8 | 1 | 1.50 | Strontium titanate | 0.40 |
| | | | | particles 1 | |
| 15 | 9 | 1 | 1.50 | Strontium titanate | 0.40 |
| | | | | particles 1 | |
| 16 | 1 | 6 | 1.50 | Strontium titanate | 0.40 |
| | | | | particles 1 | |
| 17 | 1 | 7 | 1.50 | Strontium titanate | 0.40 |
| | | | | particles 1 | |
| 18 | 1 | 8 | 1.50 | Strontium titanate | 0.40 |
| | | | | particles 1 | |
| 19 | 1 | 9 | 1.50 | Strontium titanate | 0.40 |
| | | | | particles 1 | |
| 20 | 1 | 1 | 0.10 | Strontium titanate | 0.40 |
| | | | | particles 1 | |
| 21 | 1 | 1 | 1.00 | Strontium titanate | 0.40 |
| | | | | particles 1 | |
| 22 | 1 | 1 | 3.00 | Strontium titanate | 0.40 |
| | | | | particles 1 | |
| 23 | 1 | 1 | 5.00 | Strontium titanate | 0.40 |
| | | | | particles 1 | |
| 24 | 1 | 1 | 0.05 | Strontium titanate | 0.40 |
| | | | | particles 1 | |
| 25 | 1 | 1 | 7.00 | Strontium titanate | 0.40 |
| | | | | particles 1 | |
| 26 | 1 | 10 | 1.50 | Strontium titanate | 0.40 |
| | | | | particles 1 | |
| 27 | 1 | 11 | 1.50 | Strontium titanate | 0.40 |
| | | | | particles 1 | |
| 28 | 1 | 12 | 1.50 | Strontium titanate | 0.40 |
| | | | | particles 1 | |
| 29 | 1 | 13 | 1.50 | Strontium titanate | 0.40 |
| | | | | particles 1 | |
| 30 | 1 | 14 | 1.50 | Strontium titanate | 0.40 |
| | | | | particles 1 | |
| 31 | 1 | 15 | 1.50 | Strontium titanate | 0.40 |
| | | | | particles 1 | |
| 32 | 1 | 16 | 1.50 | Strontium titanate | 0.40 |
| | | | | particles 1 | |
| 33 | 1 | 17 | 1.50 | Strontium titanate | 0.40 |
| | | | | particles 1 | |
| 34 | 1 | 18 | 1.50 | Strontium titanate | 0.40 |
| | | | | particles 1 | |
| 35 | 1 | 19 | 1.50 | Strontium titanate | 0.40 |
| | | | | particles 1 | |
| 36 | 1 | 20 | 1.50 | Strontium titanate | 0.40 |
| | | | | particles 1 | |
| 37 | 10 | 1 | 1.50 | Strontium titanate | 0.40 |
| | | | | particles 1 | |
| 38 | 11 | 1 | 1.50 | Strontium titanate | 0.40 |
| | | | | particles 1 | |
| 39 | 12 | 1 | 1.50 | Strontium titanate | 0.40 |
| | | | | particles 1 | |
| 40 | 14 | 1 | 1.50 | Strontium titanate | 0.40 |
| | | | | particles 1 | |
| 41 | 13 | 1 | 1.50 | Strontium titanate | 0.40 |
| | | | | particles 1 | |
| 42 | 1 | 21 | 1.50 | Strontium titanate | 0.40 |
| | | | | particles 1 | |
| 43 | 1 | 22 | 1.50 | Strontium titanate | 0.40 |
| | | | | particles 1 | |
| 44 | 1 | 23 | 1.50 | Strontium titanate | 0.40 |
| | | | | particles 1 | |
| 45 | 1 | 24 | 1.50 | Strontium titanate | 0.40 |
| | | | | particles 1 | |
| 46 | 1 | 25 | 1.50 | Strontium titanate | 0.40 |
| | | | | particles 1 | |
| 47 | 1 | 26 | 1.50 | Strontium titanate | 0.40 |
| | | | | particles 1 | |
| 48 | 1 | — | — | Strontium titanate | 0.40 |
| | | | | particles 1 | |

### <Example of Manufacturing of Carrier 1>

4.0 parts of a silane compound (3-(2-aminoethylaminopropyl) trimethoxysilane) were added to 100 parts of magnetite having a number average particle diameter of 0.30 μm (a magnetization intensity of 65 Am²/kg under a magnetic field of 1000/4π (kA/m)), and the obtained product was agitated by high speed mixture at 100° C. or more in this container and subjected to surface treatment. The obtained particles were magnetite A.
4.0 parts of a silane compound (3-(2-aminoethylaminopropyl) trimethoxysilane) were added to 100 parts of magnetite having a number average particle diameter of 0.50 μm (a magnetization intensity of 65 Am²/kg under a magnetic field of 1000/4π (kA/m)), and the obtained product was agitated by high speed mixture at 100° C. or more in this container and subjected to surface treatment. The obtained particles were magnetite B.
Phenol: 10 mass %
Formaldehyde solution: 6 mass % (40 mass % of formaldehyde, 10 mass % of methanol, 50 mass % of water)
Above magnetite A: 58 mass %
Above magnetite B: 26 mass %

The above materials, 5 parts of a 28 mass % ammonia aqueous solution, and 20 parts of water were put in a flask, the temperature was raised to and maintained at 85° C. for 30 minutes while the obtained product was agitated and mixed, and the product was caused to perform a polymerization reaction for 3 hours, thereby curing a phenolic resin to be generated. Then, after the cured phenolic resin was cooled to 30° C., and further, water was added to the cured phenolic resin, a supernatant solution was removed, and a precipitate was washed with water and then dried in air. Next, this precipitate was dried at a temperature of 60° C. under reduced pressure (5 mmHg or less), thereby obtaining a magnetic substance dispersion type spherical carrier 1. The 50% particle diameter (D50) on a volumetric basis was 34.2 μm.

### <Example of Manufacturing of Two-Component Developer 1>

8.0 parts of the toner 1 were added to 92.0 parts of the carrier 1, and the toner 1 and the carrier 1 were mixed using a V-shaped mixer (V-20, manufactured by Seishin Enterprise Co., Ltd.), thereby obtaining a two-component developer 1.

### <Examples of Manufacturing of Two-Component Developers 2 to 48>

Two-component developers 2 to 48 were obtained by performing manufacturing similarly except that the example of the manufacturing of the two-component developer 1 was changed to use the toner 2 to 48.

### Example 1

### <Method for Evaluating Toner>

The following evaluations were made using the two-component developer 1.

Using full-color copying machine imagePress C800 manufactured by CANON KABUSHIKI KAISHA as an image forming apparatus, the two-component developer 1 was put in a cyan development device of the image forming apparatus, the above toner was put in a cyan toner container, and the following evaluations were made. The image forming apparatus was altered by detaching a mechanism for discharging excess magnetic carrier from the development device from the development device. As paper, plain paper GF-C081 (A4, a grammage of 81.4 g/m², sold by Canon Marketing Japan Inc.) was used. (1) Evaluation of Charging Rise Properties-1: Time Constant

In the state where the toner was not replenished in the imagePress C800, the development device in which the two-component developer 1 was put was rotated for 2 hours at a speed of 500 rpm without outputting an image. In the middle, at each of the timings when 20, 50, 90, 180, 300, 600, 1200, 2400, 5400, and 7200 seconds elapsed, the developer 1 was sampled, and the amount of charge was measured.

The amount of charge (mC/kg) was measured as follows. In an amount-of-friction-charge measurement apparatus illustrated in the FIGURE, 0.15 g of the above mixture was put in a metal measurement container 2A having a 635-mesh screen 3A at the bottom of the metal measurement container 2A, and a metal cover 4A was put on the metal measurement container 2A. The mass of the entirety of the measurement container 2A at this time was weighed as W1 (g). Next, in a suction machine 1A (a portion in contact with the measurement container 2A was at least an insulator), the mixture was suctioned from a suction port 7A, and an air volume adjustment valve 6A was adjusted so that a vacuum gauge 5A indicated a pressure of 1.5 kPa. In this state, the suction was performed for 2 minutes, and the developer 1 was removed by suction. The potential of an electrometer 9A at this time was V (volts). A capacitor 8A had a capacitance C (μF). The mass of the entirety of the measurement apparatus after the suction was weighed as W2 (g). The amount of friction charge q (mC/kg) of the sample was calculated by the following formula.

$$q = C V / ( W 1 - W 2 )$$

The above test was performed under a high-humidity environment (a temperature of 30° C. and a relative humidity (RH) of 80%). The results of the test were applied and fitted to the following model formula for the amount of charge q with respect to a time t(s), thereby calculating a time constant τ(s). Q represents the saturated amount of charge (mC/kg), and q₀ represents the initial amount of charge (mC/kg).

$$Q - q = ( Q - {q}_{0} ) ( 1 - exp ( t / τ ) )$$

The calculated time constant τ was ranked based on the following criteria. That the time constant τ is small indicates that the time until saturated charging is short. It can be said that the smaller the time constant τ is, the more desirable the time constant τ is. Table 5 illustrates the evaluation results.

### (Evaluation Criteria)

AA: τ was less than 30
A: τ(s) was 30 or more and less than 100
B: τ(s) was 100 or more and less than 200
C: τ(s) was 200 or more and less than 500
D: τ(s) was 500 or more

### (2) Method for Evaluating Charging Rise Properties—2: Image Output Test

The charging rise properties were evaluated by measuring a change in density when images having different image printing rates were output. An image having a low image rate is output, thereby bringing the charging of toner in the development device into a saturated state. Then, an image having a high image rate is output. As a result, a change in density occurs due to the difference in charging between toner in which charging is saturated in the development device and toner newly supplied into the development device. Immediately after toner in which a charging rise is fast is supplied into the development device, the charging is saturated, and therefore, a change in density is small. On the other hand, it takes time from when toner in which a charging rise is slow is supplied into the development device to when the charging is saturated. Thus, the amount of charge in the entirety of the toner decreases, and the density changes.

An image output test was performed on 1000 sheets at an image rate of 1%. While the 1000 sheets were passed in succession, the sheets were passed under the same development conditions and transfer conditions (without calibration) as the first sheet. Then, an image output test was performed on 1000 sheets at an image rate of 80%. While the 1000 sheets were passed in succession, the sheets were passed under the same development conditions and transfer conditions (without calibration) as the first sheet. The image density of the 1000th sheet in printing at an image rate of 1% was set as the initial density, and the image density of the 1000th sheet in printing at an image rate of 80% was measured and was evaluated according to the following evaluation criteria. The above tests were performed under a high-humidity environment (a temperature of 30° C. and a relative humidity (RH) of 80%).

### (Measurement of Change in Image Density)

Using an X-Rite color reflection densitometer (500 series: manufactured by X-Rite), the initial density and the image density of the 1000th sheet in printing at an image rate of 80% were measured, and the difference between the image densities was ranked based on the following criteria. Table 5 illustrates the evaluation results.

### (Evaluation Criteria: Difference in Density Δ)

AA: less than 0.02
A: 0.02 or more and less than 0.05
B: 0.05 or more and less than 0.10
C: 0.10 or more and less than 0.15
D: 0.15 or more

### (3) Evaluation of Static Adhesion Force

The static adhesion force of the toner was evaluated by measuring a flying property (%). The measurement was made using an electrostatic flight method charge measurement apparatus (manufactured by Etowasu Corporation Higashiosaka Laboratory). Although the apparatus was an amount-of-charge measurement apparatus, the toner in the two-component developer 1 coating an inner sleeve was flown to an outer sleeve using an electric field during the process of the measurement, and the proportion of the flown toner was calculated, thereby evaluating the flying property of the toner.

The flying property was measured using the following method. Using the two-component developer 1, an image output test was performed on 1000 sheets at an image rate of 1%. While the 1000 sheets were passed in succession, the sheets were passed under the same development conditions and transfer conditions (without calibration) as the first sheet. Then, an image output test was performed on 1000 sheets at an image rate of 80%. While the 1000 sheets were passed in succession, the sheets were passed under the same development conditions and transfer conditions (without calibration) as the first sheet. Then, the development device was taken out, the two-component developer 1 was sampled from a development sleeve. In 1 g of the sampled two-component developer 1, the toner and the magnetic carrier were separated using the electric field separation amount-of-charge measurement apparatus under the conditions of an applied voltage of 3 kV, a time of 60 sec, a rotational speed of 50 rpm, and a gap of 3 mm between the inner sleeve and the outer sleeve. Then, when the mass of toner attached to the outer sleeve was t (g), and the mass of toner included in the sampled two-component developer 1 (=the mass of the two-component developer 1×the proportion (mass %) of the toner) was d (g), a flying property E of the toner could be calculated by the following formula.

$$The flying property E ( \% ) = t / d \times 100$$

The flying property E of the toner was set as an indicator of the static adhesion force and ranked based on the following criteria. The above evaluation was made under each of a low-temperature and low-humidity environment (a temperature of 15° C. and a relative humidity (RH) of 5%) and a high-temperature and low-humidity environment (a temperature of 32.5° C. and a relative humidity (RH) of 5%). Table 5 illustrates the evaluation results.

### (Evaluation Criteria)

A: flying property E was 85% or more
B: flying property E was 75% or more and less than 85%
C: flying property E was 65% or more and less than 75%
D: flying property E was less than 65%

### (4) Evaluation of Amount of Charge Under Low-Humidity Environment

The loading amount of the toner on paper was 0.35 mg/cm². The loading amount of the toner on paper was adjusted based on a direct-current voltage VDC of a developer bearing member, a charging voltage VD of an electrostatic latent image bearing member, and laser power. As an evaluation image, an image in which an image of 2 cm×5 cm was placed at the center of the above A4 sheet was used, and the process speed was 377 mm/sec.

The toner on the electrostatic latent image bearing member was collected by suction using a metal cylindrical tube and a cylindrical filter, thereby calculating the amount of friction charge of the toner. Specifically, the amount of friction charge of the toner on the electrostatic latent image bearing member was measured using a Faraday cage.

The Faraday cage refers to a coaxial double cylinder, and the inner cylinder and the outer cylinder are insulated from each other. If a charged body having the amount of charge Q is put in the inner cylinder, this is similar to a state as if a metal cylinder having the amount of charge Q were present due to static induction. This amount of induced charge was measured using an electrometer (Keithley 6517A manufactured by Keithley Instruments), and a value [Q/M] (mC/kg) obtained by dividing the amount of charge Q (mC) by a mass M (kg) of the toner in the inner cylinder was determined as the amount of friction charge of the toner.

$$The amount of friction charge of the toner ( mC / kg ) = Q / M$$

The above test was performed under a normal-temperature and low-humidity environment (a temperature of 23° C. and a relative humidity (RH) of 5%).

First, the above evaluation image was formed on the electrostatic latent image bearing member, and the rotation of the electrostatic latent image bearing member was stopped before the evaluation image was transferred to an intermediate transfer member. Then, the toner on the electrostatic latent image bearing member was collected by suction using the metal cylindrical tube and the cylindrical filter, and the amount of friction charge [Q/M] (mC/kg) of the toner was measured and determined based on the following criteria. Table 5 illustrates the evaluation results.

### (Evaluation Criteria)

A: [Q/M] was less than 55 mC/kg
B: [Q/M] was 55 mC/kg or more and less than 60 mC/kg
C: [Q/M] was 60 mC/kg or more and less than 65 mC/kg
D: [Q/M] was 65 mC/kg or more

### Examples 2 to 39

Evaluations were made similarly except that example 1 was changed to use the two-component developers 2 to 39. Table 5 illustrates the evaluation results of examples 2 to 39.

### Comparative Examples 1 to 9

Evaluations were made similarly except that example 1 was changed to use the two-component developers 40 to 48. Table 5 illustrates the evaluation results of comparative examples 1 to 9.

TABLE 5

| | | Evaluations of Toner Properties | | | | |
|---|---|---|---|---|---|---|
| | | Charging Rise | | Static Adhesion Force | | |
| | | Properties under | | (Flying Property E (%)) | | Amount of |
| | | High-Humidity | | Low- | High- | Charge |
| | Two- | Environment | | Temperature | Temperature | (mC/kg) |
| | Component | Time | Image | and Low- | and Low- | under Low- |
| | Developer | Constant | Output | Humidity | Humidity | Temperature |
| | No. | (s) | Test | Environment | Environment | Environment |
| Example 1 | 1 | A (80) | A (0.03) | A (93) | A (91) | A (50) |
| Example 2 | 2 | A (50) | A (0.02) | B (78) | B (77) | A (53) |
| Example 3 | 3 | A (50) | A (0.02) | C (74) | B (77) | A (53) |
| Example 4 | 4 | A (80) | A (0.03) | A (93) | A (91) | A (50) |
| Example 5 | 5 | A (80) | A (0.03) | A (86) | C (70) | A (53) |
| Example 6 | 6 | A (40) | A (0.03) | C (74) | B (77) | A (53) |
| Example 7 | 7 | C (300) | C (0.12) | A (95) | A (93) | A (50) |
| Example 8 | 8 | A (80) | A (0.03) | A (92) | A (90) | A (50) |
| Example 9 | 9 | A (80) | A (0.03) | A (92) | A (90) | A (50) |
| Example 10 | 10 | A (80) | A (0.03) | A (87) | A (86) | B (58) |
| Example 11 | 11 | A (70) | A (0.03) | A (88) | A (86) | C (63) |
| Example 12 | 12 | A (80) | A (0.03) | A (92) | A (90) | A (50) |
| Example 13 | 13 | A (80) | A (0.03) | A (92) | A (90) | A (51) |
| Example 14 | 14 | A (80) | A (0.03) | A (92) | A (90) | A (50) |
| Example 15 | 15 | A (80) | A (0.03) | A (92) | A (90) | A (50) |
| Example 16 | 16 | B (150) | B (0.07) | A (92) | A (90) | A (50) |
| Example 17 | 17 | B (150) | B (0.07) | A (92) | A (90) | A (50) |
| Example 18 | 18 | C (400) | C (0.13) | A (92) | A (90) | A (50) |
| Example 19 | 19 | C (400) | C (0.13) | A (92) | A (90) | A (50) |
| Example 20 | 20 | A (90) | A (0.04) | A (92) | A (90) | A (52) |
| Example 21 | 21 | A (80) | A (0.03) | A (92) | A (90) | A (49) |
| Example 22 | 22 | A (50) | A (0.02) | A (92) | A (90) | A (48) |
| Example 23 | 23 | A (45) | A (0.02) | A (95) | A (93) | A (48) |
| Example 24 | 24 | C (450) | C (0.13) | B (83) | B (80) | A (53) |
| Example 25 | 25 | C (400) | C (0.13) | A (92) | A (90) | A (48) |
| Example 26 | 26 | A (80) | A (0.03) | B (84) | A (88) | A (50) |
| Example 27 | 27 | A (50) | A (0.02) | B (79) | A (87) | A (51) |
| Example 28 | 28 | A (300) | C (0.12) | A (91) | A (90) | A (49) |
| Example 29 | 29 | A (50) | A (0.02) | B (79) | B (82) | A (51) |
| Example 30 | 30 | A (80) | A (0.03) | A (90) | A (90) | A (50) |
| Example 31 | 31 | A (80) | A (0.03) | A (90) | A (89) | A (50) |
| Example 32 | 32 | C (450) | C (0.12) | A (89) | A (90) | A (50) |
| Example 33 | 33 | B (150) | B (0.07) | B (78) | A (86) | A (50) |
| Example 34 | 34 | C (450) | C (0.13) | A (90) | A (90) | A (49) |
| Example 35 | 35 | C (250) | C (0.13) | C (70) | B (80) | A (53) |
| Example 36 | 36 | B (150) | B (0.07) | A (89) | A (89) | A (50) |
| Example 37 | 37 | A (80) | A (0.03) | A (90) | A (89) | A (50) |
| Example 38 | 38 | A (80) | A (0.03) | A (91) | A (90) | A (50) |
| Example 39 | 39 | AA (25) | AA (0.01) | A (91) | A (89) | A (51) |
| Comparative | 40 | D (700) | D (0.16) | A (89) | A (89) | B (53) |
| Example 1 | | | | | | |
| Comparative | 41 | D (700) | D (0.16) | A (90) | A (89) | C (61) |
| Example 2 | | | | | | |
| Comparative | 42 | D (700) | D (0.16) | A (87) | A (86) | C (62) |
| Example 3 | | | | | | |
| Comparative | 43 | D (700) | D (0.16) | A (91) | A (90) | C (63) |
| Example 4 | | | | | | |
| Comparative | 44 | D (1100) | D (0.18) | A (92) | A (91) | C (62) |
| Example 5 | | | | | | |
| Comparative | 45 | C (300) | C (0.12) | D (55) | B (80) | C (61) |
| Example 6 | | | | | | |
| Comparative | 46 | D (1000) | D (0.18) | A (91) | A (90) | C (62) |
| Example 7 | | | | | | |
| Comparative | 47 | D (1000) | D (0.18) | A (90) | A (89) | C (62) |
| Example 8 | | | | | | |
| Comparative | 48 | B (150) | B (0.07) | D (55) | D (55) | D (68) |
| Example 9 | | | | | | |

According to the present disclosure, it is possible to provide toner capable of preventing a change in image density by improving a charging rise speed under a high-humidity environment while maintaining an improvement in image quality due to a reduction in a static adhesion force under a low-humidity environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-027676, filed Feb. 25, 2025, and No. 2026-009441, filed Jan. 23, 2026, which are hereby incorporated by reference herein in their entirety.

What is claimed is:

1. Toner comprising:
toner particles containing an amorphous polyester; and
barium titanate particles present on a surface of the toner particles,
wherein the amorphous polyester includes a carboxy group,
wherein (i) the barium titanate particles include a barium titanate core and a fatty acid having carbon number 6 or more firmly fixed to a surface of the barium titanate core, and
wherein (ii) a hydroxy group amount of the barium titanate particles measured using a titration method is 15 μmol/g or more and 1300 μmol/g or less.

2. The toner according to claim 1, wherein a number average particle diameter of the barium titanate particles is 0.02 μm or more and 0.12 μm or less.

3. The toner according to claim 1, wherein the hydroxy group amount of the barium titanate particles measured using the titration method is 120 μmol/g or more and 450 μmol/g or less.

4. The toner according to claim 1, wherein an amount of the contained barium titanate particles relative to 100 parts by mass of the toner particles is 0.10 parts by mass or more and 5.00 parts by mass or less.

5. The toner according to claim 1, wherein a carbon number of the fatty acid is carbon number 12 or more and 24 or less.

6. The toner according to claim 1, wherein the fatty acid is stearic acid.

7. The toner according to claim 1, wherein the toner particles include a crystalline polyester.

8. The toner according to claim 7, wherein the crystalline polyester contains a modified crystalline polyester terminal-modified with an aliphatic monoalcohol or an aliphatic monocarboxylic acid.

9. The toner according to claim 1, wherein the barium titanate particles include 0.50 mass % or more and 5.00 mass % or less of the fatty acid.

10. The toner according to claim 1, wherein the toner includes strontium titanate particles having a number average particle diameter of 0.02 μm or more and 0.12 μm or less or calcium titanate particles having a number average particle diameter of 0.02 μm or more and 0.12 μm or less as an external additive.

11. The toner according to claim 1, wherein a ratio A/B between a hydroxy group amount A (μmol/g) of the barium titanate particles and a carboxy group amount B (μmol/g) of the fatty acid is 0.7 or more and 30.0 or less.
